(19) United States
(12) Patent Application Publication
(10) Pub. No.: US 2013/0306267 A1
(43) Pub. Date: Nov. 21, 2013

(54) Advanced protective system against dangerous caused moving water masses

(71) Applicants: Boris Feldman, Thornhill (CA); Michael Feldman, Thornhill (CA)

(72) Inventors: Boris Feldman, Thornhill (CA); Michael Feldman, Thornhill (CA)

(21) Appl. No.: 13/506,750

(22) Filed: May 16, 2012

(51) Int. Cl. E02B 7/02; B64C 39/02; F24J 3/08; B60P 1/00; A01G 15/00; E02B 1/00; B64C 37/02

(52) U.S. Cl. 165/45; 405/116; 405/114; 405/80; 244/13; 244/2; 414/507; 239/14.1

(57) ABSTRACT

The proposed advanced multi-level protective system comprises two types of barriers, harmoniously complementing to each other: a portable barrier for the protection of individual houses at the height of the floods up to 0.8-0.9 meters, and more powerful protective quick-installable barriers, suitable for mechanized installation and resistant to higher water flows up to 1.2-2 meters. The proposed advanced protective system comprises a number of additional means capable of weakening against dangerous natural processes that give rise strong water flows, and these means can weaken these flows and increase the efficiency of proposed protective barriers.

### CROSS-REFERENCE TO RELATED APPLICATION

Present application is based on the [symbol] patents and patent applications RU93018279 and U.S. patent application Ser. No. 12/386,847, patent application U.S. Ser. No. 12/930,433, Pat. App. US 20100150656, Pat. App. US 20100270389.

### TECHNICAL FIELD

The protection against flooding by the creation of special devices for protection of buildings and areas and weakening water flows in the places of their formation.

### BACKGROUND OF THE INVENTION

The problem of protection from the oncoming water flows and accompanying phenomena is one of the most significant contemporary problems of human life. The ocean tsunami in 2004 killed half a million lives; the tsunami in Japan 2011 caused a loss of tens of billions of dollars. The total damage of US in 1993 from the floods exceeds 26 billion dollars, and in 2005—125 billion (primarily the hurricane Katrina and the accompanying water flooding). The US's floods of 2011 caused damage more than half a billion dollars, and in Australia—5 billion dollars, etc. Each strong flood causes a cascade effect and violates the economy, causing frequent power and communications disconnections. The economic losses sharp increases every decade. Numerous destruction and deaths, in the first place, cause a severe financial hail in the insurance companies who can not pay the insurance at the same time a large number of people and businesses suffered from natural disasters.

Real possibilities of dams and channels are limited by material resources and territorial structures. Therefore, when the threat of flood occurs then it is erected temporary structures that can at least partially protect homes, buildings and people, and at least partially reduce the damage.

The applicants have analyzed a plurality of images published in Yahoo during to last years, and these images show that the primary means of widely used apparatus for flood protection are sandbags (closed and open), and huge amounts of ever-increasing damage shows that existing means are not able to protect against the effects of floods and other natural disasters.

Conventionally, the protective barriers can be divided into two groups: 1) the means for protecting individual homes, and 2) the means to protect whole territories, weakening the water pressure and/or directing water flows to the necessary direction. It is known many designs of individual homes protecting, in particular, U.S. Pat. No. 5,645,373 (Jenkins J. T.), U.S. Pat. No. 6,126,362 (Carter T. L. et al)) U.S. Pat. No. 7,762,742 (Smith C. E.). U.S. Pat. No. 7,762,742 represents a barrier, comprising a plurality of detachably interconnected flexible bladder units positioned end-to-end along an edge of the flood waters, each of said bladder units including a sleeve interconnected with an adjacent one of said bladder units and thereby forming a continuous barrier to prevent undesirable encroaching of the flood waters. It is really that a height of a flexible bladder filled with water and placed on plane changes is equal to (½−⅔)×diameter (without load or additional weight!!) approximately depend on the flexibility of said bladder envelope. The ground surface is not strictly horizontal and roughness that reduces additionally the actual height of proposed apparatus. An increase of the diameter of said bladders increases the time of filling of said bladders. Therefore, such apparatus may have an extremely limited use. Another type of protective barrier are shown in U.S. Pat. No. 4,136,995 (Fish D.), U.S. Pat. No. 6,079,904 (Trisl K.), U.S. Pat. No. 6,676,333 (Wiseman et al) wherein an impermeable web closes the skeleton formed with truss-like triangle-based design from the front and is located in the path of flood.

In these devices and in the device represented in U.S. Pat. No. 6,783,300 (Dooleage D.), wherein a barrier based on a sleeve filled with water, the lower part of the barrier is covered with a skirt that is bent forward and a weight is loaded on the upper surface of this skirt. However, front-weight does not eliminate the infiltration (leading edge is always rising, and it is impossible to press) and almost can not increase the barrier stability, and the heavy blocks, stones and sandbags located on said skirt in a front of barrier loss a part of their weight because of Archimedean force. Therefore, above said barriers are able to protect in the case when the flood height is not more than ˜1 meter and allow protecting separate houses. The analyze of said patents and following U.S. Pat. Nos. 4,692,060 (Jackson J. G.), 5,605,416 (Reach G. W.), 5,988,946 (Reed.), 6,164,870 (Baruh B. G.), 6,296,420 (Garbiso M. J.), 6,450,733 (Krill et al.), 6,672,799 (Earl M. D.), 6,679,654 (Wittenberg D., et al.), 6,692,188 (Walker A. G. et al.), 6,957,928 (Malcolm B. L.), 7,431,534 (Harbeck R.), 7,491,016 (Baruh B. G.), 7,651,298 (Boudeaux J. C.), 7,712,998 (Salemie B.), etc.; Pat. App. US 20040096275 (Rorheim T. O.), 20040194426 (Shapero R. W.), Pat. Appl. US 20090142136 (Thompson J. A.), 20080247825 (Bonds R. S.), 20070243021 (Tyler T. R.), 20070154265 (Stauffacher D. A.; et al.), 20070009326 (Javanbakhsh H.), 20060147271 (Cho Y. M.; et al.), 20060124913 (Keedwell C.) shows that none of proposed devices do not have following necessary properties for widespread use: 1) effectiveness, 2) the minimum sizes in the folded position, 3) low cost, 4) the possibility of easy installation around the house about an hour 5) does not require any additional components for its mounting, such components that require many space for storage, additional people for mounting except 1-2, working plumbing, etc., and these barriers have to be able to surround a house full ring fence and to compensate for possible roughness of the site (30-50%). These requirements are important that a set of owners of small houses could acquire and use such devices.

There are many designs of mobile dams and more powerful barriers, in particular, U.S. Pat. Nos. 6,428,240 (Ehrlich P. D. et al), 6,641,329 (Clement M. G.), 6,783,300 (Doolaege D.), 7,329,069 (Slater et al.), US 20030118407 (Henning G. R.), 20060124913 (Keedwell C.), 20090274519 (Shaw I.), 2010025436 (Johnson, W. N. H.), 2010025436 (Johnson, W. N. H.), 20100310315 (James P.), 20100129156 (Taylor J), 20100047019 (Hvezda P.) etc. The protection of areas and groups of houses it is need higher barriers having a height ˜1.5-2 meters. However, these devices do not have the following properties that are necessary for a wide use: 1) effectiveness, 2) quickness and simplicity of mounting, 3) the possibility of automation, and 4) an effective protection against leakage, and therefore said devices are used rarely.

However, even the most sophisticated means can protect only individual homes and partially separate territories. An attempt of very large area protection, using only the dams, will cause the water level to increase because of the limited capacity of the remaining water area and the limited capacity of drainage systems. And then the height of used darns would be not enough. Therefore, the protection against floods requires reducing the intensity of water flows (the ratio of the water flow volume to the time interval) and the total volume of water flows. It is important especially now, when the number of abnormal climatic processes and strong catastrophes increases. A unified security system, covering not only the protection of individual houses and individual areas, but also on all stages of the formation of increasing water flows, is required.

There are four main natural processes that cause dangerous floods: 1) intensive melting of snow masses that have accumulated in the winter, 2) heavy rains, in particular, the monsoon rains, 3) hurricanes, carrying huge amounts of ocean water, and 4) tsunami and surge waves. These processes are related to the huge mass of water in a short time that can not be removed by any natural or artificial drainage systems. This causes a sharp rise of water level. Therefore, the main task is to reduce the intensity of water flows, which will allow better using of water removed systems and to organize a more effective protection of buildings and areas.

The authors (patent application U.S. Ser. No. 12/930,433, Feldman et al.) proposed a method for reducing the intensity of melting, using the heating of separate snow arrays to cause some melting of the earlier melting of one part of snow and the refrigeration of others to delay melting. It is known methods for removing snow from roads by forcing melting. These methods use geothermal water and geothermal pumps for pumping water (JP 2010281493 (Kamiyama Hiroaki), or the accumulation of warm water in summer, pumping this water in underground tanks, and further pumped back said water in the winter. Each of these methods requires energy to pump water.

No projects allowing managing monsoon rains are known.

There are many known methods of controlling hurricanes, which are analyzed in US 20100270389, Feldman et al) and in patent application U.S. Ser. No. 12/930,433 (Feldman et al.). Many papers and patents dedicated to the fight against hurricanes. The only practical experiment “Storm Fury” is known. It is made in USA during the 1963-83 periods with uncertain result. Further the gel Dyn-O-Gel having the unique adsorptive properties gave a hope. But to no avail. The hurricane has energy of the order of 10¹⁷ Joules and front density of 100 J/sq. cm. that makes unrealistic most of the proposals. R. Hoffman has built a computer model, which proves that the most effective to suppress hurricane is the deprivation of coming power.

The first way is connected to the cooling of the ocean surface in the path of the hurricane. This is possible with the help of creating a sufficiently broad band of much colder water. This is possible either through artificial, upwelling deep cold water (Dann et al., Kirke B.), or through creating a powerful ascending hot air flow that is able to cool ocean surface (Alamaro M.). The first way can be realized by installing a set of long vertical pipes submerged in water in the path of the hurricane (US Pat. Appl. 20,070,270,057, Feldman B.), that offered to produce a vertical pipe for upwelling of a flexible material that can be deliver rapidly. See also US Pat. App. 20080175728 by Kithil P. W. et al. The second way proposed by the Alamar M. demanded to delivery and install a barge, on which 20 aircraft turbojet engines are mounted and their nozzles are directed vertically upwards. Hurricane that met with said barge would not receive much-needed energy and come ashore significantly being weakened. But as can deliver this band in the right place at the right time? Only the construction proposed in US Pat. App. 20070270057 (Feldman B.) and in patent application U.S. Ser. No. 12/930, 433 (Feldman at al) allows executing it, using <<parachuted” a lot of folded pipes from the aircraft at the right time and right place that can automatically turn to a working state. Additionally, the Impact against tornadoes and hurricane using a lot of rockets filled with oxygen-deficit fuel that allows violating the mechanical dynamics of the vortex, and the electrical field (US Pat. App. 20020088364 (Feldman B). The unique proposals for to combat against the tsunami wave are 20100150,656 and Ser. No. 12/930, 433 (Feldman B. et al.) use of electrohydraulic generators (EHG) are improved in the present invention.

The total path of attenuation of said dangerous natural processes is to fight against global warming. According to statistics global warning causes the increase of frequency and intensity of said dangerous processes, that by-turn provokes the increase of flood damage.

There are many projects to fight against global warming, but not all have real prospects. Use of space-screens (Angel project, Benford project) is expensive and dangerous, any error or climate change will require huge efforts for their correction, and, finally, the blackout of all countries will never be able to agree, because warming for individual countries can be helpful. The same remark is true for screens placed in orbit. Inflatable screens, towed with an aircraft (U.S. Pat. No. 7,726,601, Hershkovitz B.) can be used only in the case of a single small screen; the sizes are limited by the action of non-constant wind. In addition, such devices can not be used in a dense group. When towing neighboring screens must be on a sufficiently large distance from each other, otherwise they will only interfere with each other that easily lead to an accident towing aircraft.

The next group of projects offers to make a screen from a plurality of passive bodies in the atmosphere. The best known is proposal to spray sulfur aerosols in the atmosphere (Teller E., Budyko M., Crutzen P., Brocker W., Israel Ju.), prompted by volcanic eruptions. Being technically feasible, it also affects

interests of all countries, and their effects is unclear, as is proved that aerosols deplete the ozone layer. In addition, their effect depends on the region, can shorten the life of the clouds and increase the methane potential warming. An opposite variant is proposed in Pat. App. US 20100270389 (Feldman et al.) It proposed to use small particles, particularly, frozen soap bubbles. These bubbles require not more material than aerosols for creating the equivalent screen, but these bubbles have a limited “lifetime”. They “live” above limited area and do not cross borders of neighboring countries that is very

In 2007, J. Lovelock and C. Rapley proposed the construction of ocean pumps to pump water (a plurality of vertical tube having a 10-meters diameter and 100-200 meters length) up from below the thermocline to “fertilize algae in the surface waters and encourage them to bloom”. The basic idea was to accelerate the transfer of carbon dioxide from the atmosphere to the ocean by increasing primary production and enhancing the export of organic carbon (as marine snow) to the deep ocean. This procedure can cause the opposite effect: the thermal radiation over a cold surface decreases, the surface layer of warm water heats the ocean depths, and the total amount of heat will increase.

The next group of projects is associated with the direct absorption of the main greenhouse gas CO2 to reduce greenhouse effect and to weaken global warming. Global Research Technologies (GRT) has announced its success in ongoing research and development of a proprietary air-capture system to remove carbon dioxide (CO2) from the atmosphere. K. Lackner of Columbia. He offers a method “air-capture system” that require to create a set of 380000 towers having more 300 meter of height) for chemical absorption of CO2 directly from air. This project does not demand preliminary gathering CO2 (it is very important), but chemical absorption is connected with essential energy expenses. This project does not demand preliminary gathering CO2 (it is very important), But it uses Ca (OH) 2, for which manufacturing it is necessary the natural limestone CaCO3 preliminary decomposed to produce CaO that is associated with the release of CO2, and said CO2 it need also to absorb.

One of authors of the present application proposed to intensify the natural process of absorption of carbon dioxide with ocean water surface by the way of creating an artificial vertical movement of water and the accumulations of carbon dioxide by natural sinks (clams, corals, etc.), using the up/downwelling (Feldman B. RU App. 93,011,572). Said sinks are able to accumulate said CO2 in the skeletons. But this process requires additional amount of Ca. This application offers a solution of this problem.

But in addition, corals are very important for mankind. “The existence of half a billion people depends on them,” and “Over a quarter of all fish species are also dependent on the coral reefs.”—Pavan Sukhdev, the head of the project of UN's Environment Program. It is estimated that annual coral reefs provide, for goods and services, 375 billion dollars, in whole or in part providing the existence of a tenth part of mankind. Therefore, the project associated with the development of the coral to absorb CO2 could pay for itself entirely.

### SUMMARY

The modern conditions are characterized in that the frequency and intensity of extreme weather events is increasing, as shown by observations of the past 50 years. The danger of the catastrophic flooding caused a cascading effect, such as floods in eastern Australia (February-March 2012) also increases. The proposed advanced multi-level protective system includes a means intended for the immediate protection of people, buildings and areas, as well as and additional funds for operations against natural hazards, are responsible for their formation of hazardous water flow, reducing their intensity and correspondingly reduce the intensity of floods, improving thus the effectiveness of protective barriers. Height, stability and length are determined by the real possibilities of people.

The first aspect of present invention consists in that, that the proposed multi-stage system includes, at first, very simple portable barriers that can not protect against the non-strong waves up to the height of 0.8-1.2 meters approximately, corresponding to problems about 90% of the American plains, and, at second, the more complex quick-installable barriers that are able in many cases to protect the areas and to weaken the water flow reaching said portable barriers.

The following aspect consists in that it is proposed two types of the most popular portable barrier. The first requires minimum previous preparation of areas surrounding protected homes or buildings—mounting a set of previous buried anchored blocks equipped with gripping and fixing socket. Such modification doesn't using heavy ballast that appreciably simplifies and accelerates the installation of such barrier. Another modification doesn't require previous buried anchored blocks, and uses ballast of any type. In addition, proposed design allows using sleeves to prevent the infiltration either sleeve filled with water/air, or “sleeve”—cable filled flexible plastic.

The following aspect of this invention consists in that said portable barriers use only the simplest components, but and being stacked occupy a minimal amount and can be installed very quickly by two or even one person. The installation of these portable barriers does not require sand or ballast. Within certain limits said portable barriers can adapt to roundness of land. The sleeve protecting against leakage can have a small diameter (10-15 cm), and requires a simple pump to fill with water or air. Other embodiment of said sleeve uses a soft flexible stocking filled with fillers such as rubber or rubber-like plastic requiring no pump, no water. In addition, such flexible sleeve is not afraid of accidental damage or punctures.

The following aspect of this invention consists in that proposed design of the quick-installable barrier that can stop the water flows up to 1.5 and more in height and that can become a basis for the protection of large areas, able to protect separate buildings protected portable barriers. These quick-installable barriers, which can be quickly installed, can be quickly prepared for the practical protection. Its U-shaped foldable, easily transportable housing has a harmonica-like envelope, sectionalized, which being folded can be suspended on a conveyor, mounted on a movable platform, for example, a truck, and that can be easily deployed on the ground when said truck is moving. The to the geothermal devices are located in the places where huge snow masses are accumulate and to include these devices for melting initiation melt (1) in early winter reducing said snow masses accumulation, (2) in cold winter initiating snow melting and following inevitable freezing and forming slowly melting ice masses, and (3) in early spring initiating forestalling snow melting masses.

Another aspect consists in that common heat pump geothermal devices and more simpler L-shaped self-supporting geothermal devices having one or more one-way valves that are more effective in the cold period.

Another aspect consists in that said self-supporting geothermal devices can comprise a built-in occasionally working mixer allowing to use these devices for de-icing roads and for home heating even during sharp frost after prolonged warm weather.

Another aspect consists in that these simpler geothermal units operating in the self-sustaining mode can be used for purposes, they are environmentally friendly, independent of hurricanes, ice wire, many man-made disasters, can be used in the icy period as a backup power source in an emergency.

Another aspect consists in that the proposed screen that can be formed by a plurality of said UAVES has a rectangular plan approximately at least in flight allows creating the most dense covering from said UAVES and, secondly, as most as possible to use their area for an energy collection.

Another aspect consists in that for screening large areas of said UAVES having an extended surface it is used a thin plastic film (reflecting or absorbing), which stretches between the fuselages after takeoff and before landing may be folded that makes easier to overcome the strong winds in the troposphere.

Another aspect consists in that for screening solar warm radiation the one or more fuselages unmanned aerial vehicles are proposed, said UAV intended for flights at heights 16-30 km using solar energy that solar cells covering upper surface of said fuselages generates and wherein the space between said fuselages is covered with one or more thin rigid or flexible non-transparent film strips at least in-flight (unmanned aerial vehicle with an expanded surface—UAVES).

Another aspect consists in that the proposed UAVES use one or more electric propeller motors and batteries or super capacitors that allow using solar cells placed on the fuselage's and wing's surfaces to provide round-the-clock work eliminating the need for environmentally harmful fuels.

Another aspect consists in that the algorithm of said UAVES horizontal movement in the flock is proposed, this algorithm allows enough tight covering given space, and thereby reduce the temperature of given area or given cloud that are located under this screen. The algorithm allows the moving flock receiving additional speed in the perpendicular or other predetermined direction of such magnitude to rotate the speed vector in the desired direction, and the increment is formed when the row (rank) of said UAV is perpendicular to a given direction and its speed coincides with the desired direction

The following aspect consists in that said UAVESes are able to fly in the form of an ordered flock and to form a sufficiently dense screen above rain cloud, saturated with moisture and dangerous by the subsequent flood on land, protecting against sun rays to promote the formation of ice crystals as centers of condensation, to promote rain falling in the necessary place chosen from: above ocean to prevent flooding on land or more safer area of land. This screen allows protecting given ground-based areas from heavy shower and possible dangerous flooding, depriving said rain cloud of a part of heedless and dangerous water.

The following aspect consists in that said screen formed above ocean tropic areas heating more known value (˜26.5° C.), where it is possible the origin of hurricanes, allows preventing this process or weakening growing hurricane.

The following aspect consists in that said screen formed above arid ground zone allows weakening water evaporation and easing arid danger.

The following aspect consists in that said screen formed above exsiccant lake allows weakening water evaporation and helping water level maintenance.

The following aspect consists in that said screen formed above ocean area [symbol] [symbol] [symbol] [symbol] [symbol] [symbol] allows increasing an absorption of CO2 by water surface layer.

The following aspect consists in to use a plurality of bubbles filled with high pressure steam to weaken fast-moving water masses in tsunamis and hurricanes by the way of dividing these water masses into droplets that dramatically increases the total surface and, respectively, an air resistance, splitting into layers violating their joint motion, breaking the energy exchange and causing an energy loss due to mutual collisions and additional air resistance.

The following aspect consists in that electrohydraulic generators (EHG) are used to generate a plurality of bubbles filled with high pressure steam under water, and said generators are equipped with electrical energy sources in the form of storage batteries, batteries, super capacitors, fuel engines or atomic mini-reactors.

The following aspect consists in that said one or more said EHGs are located inside housings and capable of generating bubbles filled with high pressure steam as a result of spark discharge between output electrodes or a burning of thin metal jumper under water. The housings are belonged to the missiles of one or the following types: (1) simplest missiles (bullets) that are able to generate a single bubble; (2) missiles in the form of passive disks that are able to move together with water stream and to generate a few said bubbles; (3) missiles-torpedoes that are able to generate a few said bubbles moving along given trajectory; (4) missiles-torpedoes that are able to generate a plurality of said bubbles moving along trajectory that is defined with regard to the given task and/or the reading of sensor(s).

The following aspect consists in that said missiles and missiles-torpedoes may comprise depending on their complexity a control unit connected to an engine using separate propulsive agent or recoil as a result of bubbles generation and: (i) said missiles can comprise sensor(s) of, chosen from the followings: pressure, time delay (timer), acceleration, or temperature to define a time moment of landing on water; (ii) said EHG, using said thin metal jumper for steam bubbles generating, comprises an automatic unit to change the burnt jumper as it burning; (iii) said output electrodes are located inside said housing for missiles of 2-4 types and on their surface so that the recoil after the generation of each bubble would be either compensated or directed along the longitudinal axis without disrupting the movement direction.

The following aspect consists in that said EHG can be used as a torpedo engines, main and auxiliary, as well as the creators of the bubble envelope, which allows significantly reducing water resistance to movement of the torpedo and, correspondently, increasing their speed.

The following aspect consists in the weakening of tsunami waves a plurality of said bubbles filled with high pressure steam that are generated by generators located inside missiles, which are run from airplanes or helicopters in the water mass of the growing wave, so that: (1) a plurality of said simplest missiles (bullets) are sent to any party to the thickness of the growing wave, (2) a set of said passive disks are thrown into the wave from behind, they float together with this wave at a certain depth and generate said bubbles; (3) a plurality of said missiles-torpedoes that are able to generate a few said bubbles moving along given trajectory attack from the sea or along said wave, so that they long move together with the growth wave.

The following aspect consists in the weakening of tsunami waves by the simultaneous action of high-power lasers, using a lighthydraulic effect, and a plurality of said bubbles generated by said generators located inside said torpedoes at the growing hump, and the laser rays are directed into the surface turbid water layer, and said torpedoes are directed into the more lower layer.

The following aspect consists in that two known directions of energy sources for electro cars connected with the researches of super capacitors and batteries (accumulators) permit to create missile-torpedoes for struggle against tsunami wave, missiles having limited size and weight, suitable for mass launching into growth tsunami waves and capable of creating a sufficient number of said bubbles filled with steam of high pressure. It is significantly that the requirement of self-discharge rate and design life that is very important for electro cars are absent.

The following aspect consists in that the proposed means of attack against the tsunami are based on modern distributed systems of sensors, cable sensors and the possibilities of analysis of distribution of GPS-signals in ionosphere, caused by the rise and fall of tsunami waves, allows a half-hour and more ahead of the tsunami attack determining the risk, the direction, and the place of growth wave, preparing the effective protection, and weakening one, two or three tsunami waves. In parallel, the mobile or stationary means for this purpose can be created on the shore, as well as a group of underwater generators in the most dangerous areas.

The following aspect consists in the weakening the hurricane by the way of the attack of a group of said missiles-torpedoes that are able to generate a plurality of said bubbles moving along trajectory, trying to create as possible more continuous ring of bubbles under the eyewalls to disrupt the energy flow feeding the hurricane trunk from below. At the same time, said missile-torpedoes having no means of accurate motion around the hurricane under its eyewalls go on a tangent, come to the surface, turn around and go on a tangent again, repeatedly. In cases when said torpedoes have the sensors that can ensure the necessary follow-up they move around.

The following aspect consists in that said above actions can be combined with the actions against a hurricane trunk (and, of course, against a tornado trunk) comprising: 1) missiles filled with FAE, and 2) laser pulses, using lighthydraulic forces, choosing the more thin zone of vertical trunk, and in the case of a tornado—at least, at a height of several hundreds meters, so as don't touch to ground based structures.

The following aspect consists in the use a plurality of sea unmanned ships (or stations anchored to the bottom) circulating in the vicinity of coral colonies that produce bicarbonate in the result of reaction between renewable portions of the limestone and sea water flow, in which CO2 absorbed from the air above the sea surface has been dissolved, further the resulting bicarbonate washed with water in the direction of said colonies, compensating a calcium deficiency that is a result of building of coral skeletons. These ships can be supplied with solar energy and/or towed energy converters that transform the energy of wind moving this ship into electricity, and that are completely self-contained and environmentally friendly.

The following aspect consists in the maximum intensification of growth of corals and other skeletogenous marine organisms that absorb CO2 by the skeletons creation and photosynthesis, by the way using the known means, in particular, the lighting, pumping colder deep water, nutrient-rich, metal frames (wire, tape) fed by converters of wave energy to electricity, the creating of protected areas against starfishes.

The following aspect consists in the collection and accumulation of environmentally friendly solar energy with two or more fuselage unmanned aerial vehicles with an extended surface, designed to fly at heights of 16-30 km, the entire upper surface of which, including the space between these two fuselages, is covered with solar panels connected to a storage battery or super capacitor.

The following aspect consists in that the proposed two-stage scheme of the collection, storage and transfer of solar energy that allows separating the function of collecting solar energy requiring an expanded surface and, consequently, a more relaxed air conditions, and the transfer function, requiring agility and ability to fly in the troposphere.

The following aspect consists in that the proposed algorithm for horizontal movement of said unmanned aerial vehicles in the flock allows not only sufficient tight covering a given space, but also leaving the flock, transferring energy to the transport vehicle and coming back without disrupting traffic.

The following aspect consists in that the two ways to transfer the accumulated solar energy transport vehicle are proposed: (1) by the way of the exchange of energy blocks (storage batteries or super capacitors) using the conveyor exchange, or (2) by the way of directly charging the battery on the unmanned aerial transport vehicle, and the subsequent exchange of said blocks on the ground.

The following aspect consists in the possibility of using the energy that said transport vehicle had been received for (1) the rain delay by the way of heating a rain cloud upper surface and melting ice crystals that are the centers of condensation of moisture in the cloud or (2) to raise the temperature agricultural area at the time of frost.

### BRIEF DESCRIPTION OF THE DRAWING

FIGS. 1A-1H illustrate a portable barrier. FIG. 1A shows a common view of a first embodiment of said barrier; FIG. 1B shows a common view of a second embodiment of said barrier, comprising additional supporting members; FIG. 1C shows three embodiments of said barrier, comprising additional platforms for ballast loading; FIGS. 1D-1F represent three embodiments of a front anchored block, correspondently, using a buried block, a sharp spike, and a bearing plate; FIG. 1G represents a cross-section of a front part of said barrier; FIG. 1H represents a rear anchored block in the form of a trail spade for the first and the second embodiments.

FIGS. 2A-2H represent a sleeve and a connection of two tubes. FIGS. 2A and 2B represent two variants of said sleeve; FIG. 2C represents a “sleeve”—cable; FIGS. 2D-2E show the connection of two tubes and four tubes, correspondently; FIG. 2F shows a wrap of the two tubes connection; FIGS. 2G and 2H represent said “sleeve”—cable made from resilient ribbon-like material.

FIGS. 3A-3E illustrate a limiter and mutual positions of the limiter and the sleeve. FIGS. 3A-3B represent a top and a side views of the limiter; FIG. 3C shows a mutual position of the limiter, the sleeve and the front member; FIGS. 3D and 3E illustrate two variant of the pressing said sleeve to the terrain surface through the web.

FIGS. 4A-4D show a vertical fragment of the web. FIG. 4A shows an external view of the web; FIG. 4B shows pleated edges of said web; FIG. 4C illustrates a view of said portative barrier inside; FIG. 4C shows a view of said barrier located on uneven surface; FIG. 4D represents said sleeve filled with water and located on a hillside.

FIG. 5 shows a framework of a quick-installable barrier.

FIGS. 6A-6E show three embodiments of cross-section of said quick-installable barrier and frame-spreaders. FIGS. 6A-6C show cross-sections; FIGS. 6D-6E represent top views of said frame-spreaders shown in FIGS. 6A and 6B.

FIGS. 7A-7D illustrate the location of folds and the process of folding said quick-installable barrier. FIG. 7A and FIG. 7B show the location of the folds; FIG. 7C illustrates a process of folding; FIG. 7D shows a stowed envelope.

FIGS. 8A-8D illustrate a process said quick-installable barrier mounting. FIG. 8A shows a process of the quick-installable barrier framework mounting; FIG. 8B illustrates a ballast loading. FIG. 8C represents an auxiliary bag placed inside a barrier section. FIG. 8D represents a folded section.

FIGS. 9A-9B represent two structure built on the base of said quick-installable barriers. FIG. 9A shows a channel for flood water removal; FIG. 9B shows a top view of said quick-installable barrier.

FIGS. 10A-10B illustrate a possibility of heating of snow mass. FIG. 10A shows a possible change of the melting intensity; FIG. 10B shows a geothermal station for controlling of snow melting and heaters placement.

FIGS. 11A-11E illustrate U-shaped and L-shaped thermal stations that are able to self-supporting mode. FIG. 11A represents the U-shaped station; FIGS. 11B-11D represent the L-shaped self-supporting thermal station and its fragment; FIG. 11E shows a power sources scheme.

FIGS. 12A-12F illustrate various practical embodiments of thermal stations. FIG. 12A-12C illustrates the use of the self-supporting geothermal station for removing snow from roads by forcing melting; FIGS. 12C-12E illustrate the use of variants of said geothermal station for the home heating; FIG. 12F illustrates a placement of said L-shaped device under a plant.

FIGS. 13A-13B illustrate a dirigible. FIG. 13A shows a top view of a dirigible-Hybrid; FIG. 13B shows apparatuses attached to the dirigible.

FIGS. 14A-14F show a unmanned aerial vehicle having an extended surface (UAVES). FIG. 14A a top view of said vehicle; FIG. 14B shows a side view of said vehicle; FIG. 14C shows a top view of a membrane; FIG. 14D shows a front edge of the membrane inside the front wing; FIG. 14E shows a placement of the lateral edges of said membrane; FIG. 14F shows a through air notch made in the membrane.

FIGS. 15A-15H show the possibility of the uses of TUAV. FIG. 15A shows a view of said TUAV, FIGS. 15B-15C show two schemes of the use of said TUAV for rain delaying; FIGS. 15D-15F represent three schemes of terrestrial surface heating; FIGS. 15G-15H illustrate the use of said TUAV for de-icing air cables.

FIGS. 16A-16B illustrate a group of the UAVESes that form the flock and screen the terrestrial surface directly or the upper surface of rain cloud.

FIGS. 17A-17C represents a structure of said flock. FIG. 17A shows a view of said flock, FIG. 17B illustrates the need of a gap, FIG. 17C illustrates a possible cooperation between adjacent UAVESes.

FIGS. 18A-18E represent three possible variants of the energy exchange between said UAVES and TUAV. FIG. 18A represents said exchange in the of direct contact between said vehicles; FIG. 18B represents the exchange blocks; FIG. 18C represents a conveyor scheme of said exchange; FIGS. 18D-18E shows a variant of direct charging blocks located inside said TUAV.

FIGS. 19A-19E represent a missile for an active protection against tsunami waves and hurricane trunk. FIG. 19A shows a special missile; FIGS. 19B-19C represent exemplary schemes of an EHG; FIGS. 19D-19E represent an example of floating discus torpedo (correspondently, a front view and a top view).

FIGS. 20A-20F represent a torpedo for an active protection against tsunami and hurricane trunk. FIGS. 20A-20B show a cross-section of said torpedo; FIGS. 20C-20D are two variants of a sectional view taken along line A-A of the torpedo (FIG. 19A); FIGS. 20E-20F illustrate a nozzle of EHG and a set of jumpers.

FIGS. 21A-21H illustrate various ways of the attack against tsunami. FIG. 21A illustrates an example of laser ray action; FIG. 21B illustrates joint action of laser rays and special missiles on tsunami wave; FIG. 21C and FIG. 21D represents a scheme of a shore deference; FIGS. 21E-21H illustrate joint action of laser rays and special missiles on hurricane trunk.

FIGS. 22A-22E illustrate advance coral colonies. FIG. 22A shows a structure of coral colonies; FIGS. 22B-22C represent variants of Ca (HCO3)2 formers; FIGS. 22D-22E show several fragments of said former.

### DETAILED DESCRIPTION OF INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

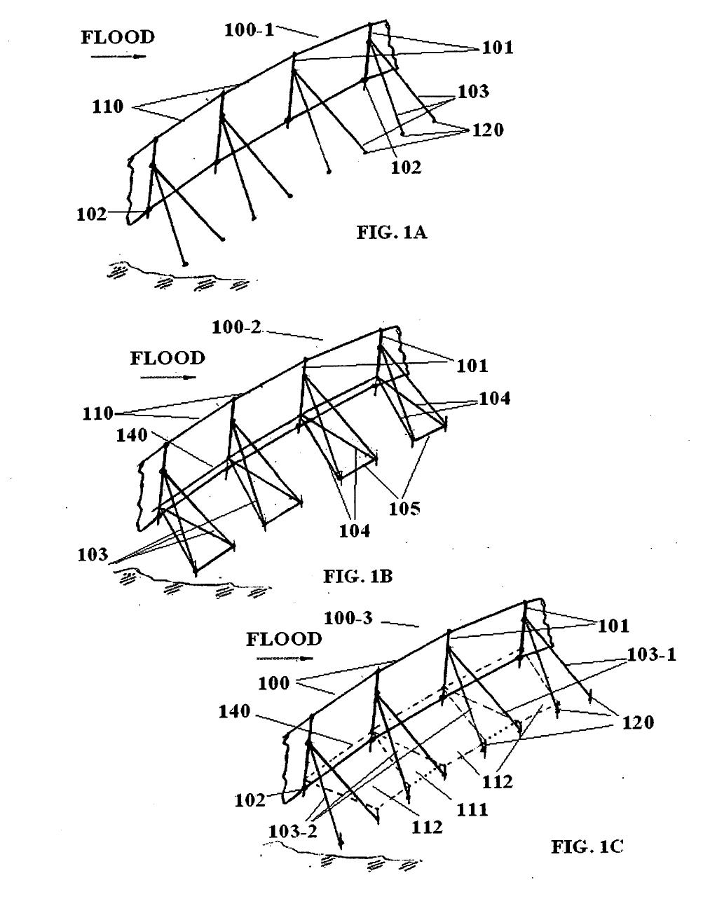

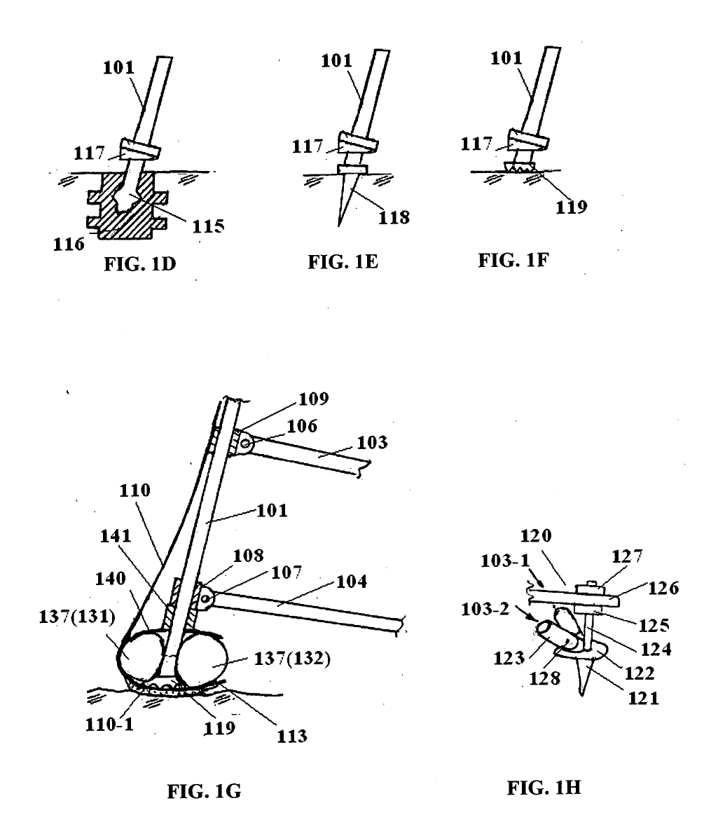

FIG. 1A shows a portable barrier 100-1. Front members 101 fastened into the front units 102 are the base of said barrier. These members can be tubes or a various special profile. Each said front member is supported, for example, by two additional supporting members 103 that lean on rear anchor block 120 and form a stable tripod. The additional members are fixed in the ground like said front members, can simply lean on the ground or can lean on step-bearings that are buried into the ground (it is not shown). Said additional members 103 of each tripod can be connected to said front members 101 with the help of clamps (that are not shown) at a height 0.3% approximately from said front member height. Each of pair of these additional supporting members are located symmetrically relatively the plane perpendicularly to the conditional smooth surface that passes through said front members 101. The front member and supporting members 103 can be extensible. A flexible impermeable elongated web 110 is stretched over said front members 101 and is fastened to said front members 101 from above with the help of clamps or by other means (it is shown).

FIG. 1B represents the second embodiment 100-2 of said barrier. Auxiliary members 104 and based members 105 can be used in the case if said front members 101 lean on the bearing plates 102 (below). At same time a limiter 140 is shown (see below). FIG. 1C represents the third embodiment 100-3. The auxiliary members 104 and based plates 105 set off or form frames 112 and/or 111 intended for ballast loading.

FIG. 1D shows a front anchor block 116 including a socket 116 (or a nest, a clip, or other) for inserting a plug 115 mounted on the end of the front member 101. Such block 116 can be made from concrete, plastic or metal and preliminary buried into the ground at the equal distance approximately. The front member can be fixed using known devices, for example, a bayonet. Said sockets can have a cover to be not strewed over soil. A leveling washer 117 is shown. FIG. 1E shows the second variant using a spike with a limiting washer 118. FIG. 1F shows the third variant using a bearing plate 119.

FIG. 1G represents a fragment of cross-section of said barrier. The front member 101 leans on the front bearing plate 119, the bottom surface of which is covered with sharp teeth. The web 110 covers the palisade of said front members from the front, and its lower edge bends back in the form of a prolonged part 113. This plate 119 presses said prolonged part 113 to the terrain surface through a hydrophobic wood-like layer 110-1. A limiter 140 presses two tubes 137 forming a sleeve to the front member 110 and the layer 110-1 to terrain surface though the prolonged part 113. Further it is possible two embodiments: (1) the nut 141, screwing down of which sets the pressure to said limiter 140 during said barrier mounting and holds this pressure; (2) ballast located on the frame 111(112) presses to said limiter 140 through the levering washer 141 using a coupling 108 and a hinge 107. The supporting member 103 is connected to the front member 110 through a coupling 109 and a hinge 106.

The rear trail spade 120 (FIG. 1H) includes a spike 121 intended to insert into ground like field lightweight artillery, a limiting plate 122 that can include a lever (not shown), a central rod 125 and one or two sockets 123 intended for inserting said supporting members 120 and include a hinge 128. The variant FIG. 1H allows fastening two adjacent supporting members 103-1 and 103-2 in same time if they are located closely. This rod 124 is intended for mounting said horizontal plates 111, 112 (shown as 126) between a collar 125 and a locknut 127. In the variant FIG. 1A (without said plates) said rod 124 can be absent.

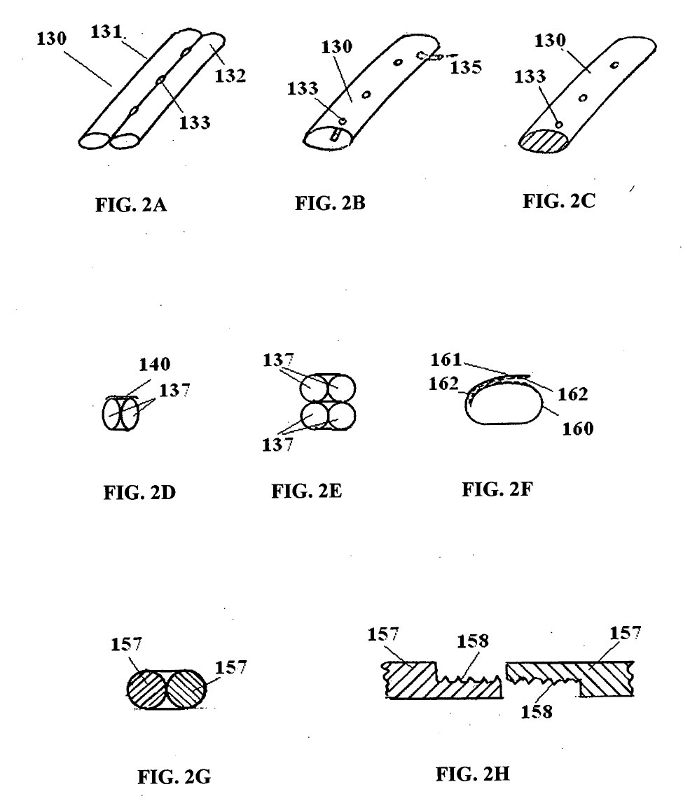

FIGS. 2A-2C represent three variants of an elongated air/waterproof inflatable sleeve 130. FIG. 2A represents said double sleeve comprising two tubes 131 and 132, tightly connected to each other by welding or gluing, between which the through-holes 133 are made for the front members passing. FIGS. 2B-2C represent single cylinder wherein said through-holes are made in the form of inserted pipes 133 by welding or gluing. An inlet branch-pipe 135 is intent for connecting to a filler source 135, for example, a pump, a gas (or air) cylinder that is pressurized, or a tank filled with water placed at a height of 1.5 meters or more. for filling with water or air is shown. FIG. 2C represents another variant of single cylindrical sleeve 130. This sleeve can be filled with rubber-like or flexible granules. Such sleeve doesn't afraid of pinholes. FIG. 2D shows said sleeve including two extended up tubes 137. FIG. 2E represents a combined sleeve including two pair of tubes. FIG. 2F illustrates a wrap 160 that allows connecting two tubes to each another. It can be fastened also using adhesive cover. The wrap 160 that is shown with an open covering part 161 can be closed and fastened using velcro-type or high adhesive covering 162. FIG. 2G shows as two “sleeves” or cables that is filled with (raw) rubber-like or flexible granules can be connected to each other. FIG. 2H shows that such “sleeves” can be made in the form of separate pieces. These pieces 157 are conveniently stored and easily connected with each other. A diametrical cut 158 with ribbed surface allows connecting two pieces with each other, and then the place of connection it can be fastened using adhesive tape or a wrap 160 (FIG. 2F).

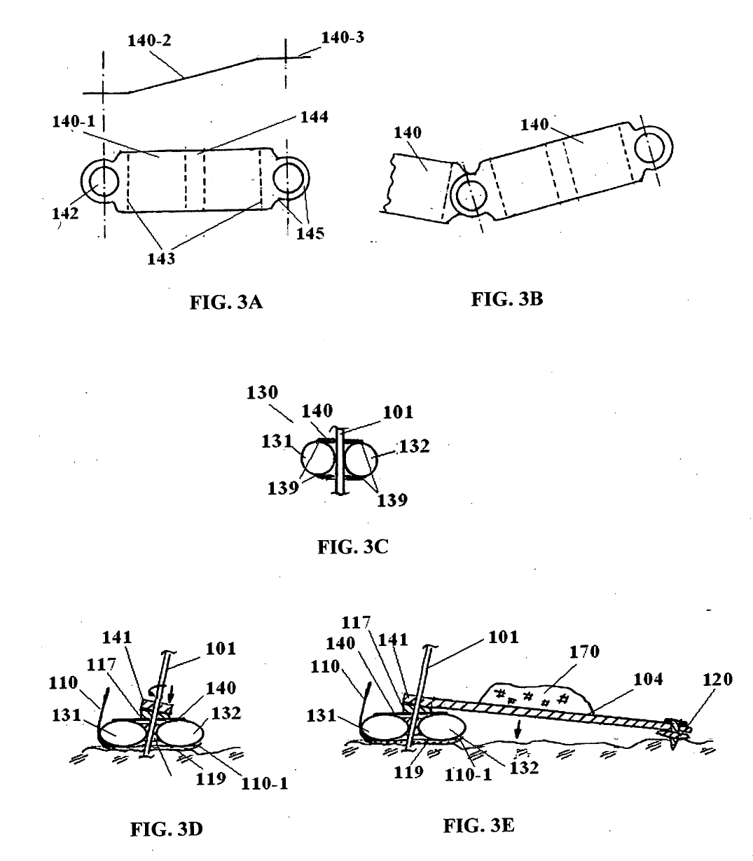

FIG. 3A shows two views of one section of the limiter 140. The adjacent front members 101 pass through these opening 142. The side view shows a central part of said limiter 140-2 and two outside parts 140-3. Two shows bends accord to hinges 143 (the top view). The top view 140-1 shows two openings 142 intended for passing two adjacent said front members that are connected with this section. The lines 143 are the lines of possible bends that allow mounting said barrier in the case of even terrain surface. The side view 140-2 illustrates such bend. These bends can be made in the form of hinges or pasted-in flexible elements. The strip 144 represents a sliding (extending) section that allows using this section in the case when the distance between adjacent front members isn't constant because of topographic features. A smoothed form 145 may be useful to angled sections do not interfere with each other if the barrier is bent in the horizontal plane. This limiter can be convex upwards and can be made from metal or plastic. The convex upward or “upward and back” of said limiter allows concentrating the pressure that to said inflated sleeve FIG. 3B illustrates said angled position of said sections 140. Another embodiment of said limiter can have only one opening (not shown).

FIG. 3C illustrates the double sleeve according to FIG. 2D, wherein two several cylindrical tubes 131 form connected together by elastic strips 132 with the help of glue or welding 139. They can be connected to each other using a wrap 160 (FIG. 2F).

This sleeve filled with air or water and pressurized forces the web 110 (FIG. 3D) presses against the ground directly or through a soft hydrophobic and/or cotton-like layer 110-1 impeding entering of flood water. Said sleeve can have 3-8″ in diameter. FIG. 3D Illustrates the first variant, wherein as a result of the screwing said nut 141 compresses the limiter 140 that squeezes the sleeve 131-132. This sleeve presses the web 110 through a layer of 110-1119 to the terrain surface, preventing the infiltration of water. In FIG. 3E ballast 170 located on platform creates the pressure for preventing the infiltration of water. The platform can be made in the form of metal or plastic or wooden plate fastened to members 104. This platform can be made in the form of flexible material stretched on said members 104, the limiter 140 and the based member 105 so that said frame leans only on the limiter 140 and rear blocks 120. It is possible to include additional crosspieces between said details 104, 140 and 105 so that said ballast or platform doesn't touch with terrain surface.

The lower covering depends on the soil properties. Said hydrophobic cotton wool-like fiber is more convenient for sandy soil. For a dense surface track (asphalt, concrete) are more suitable high-adhesive coating, like, for example, polymers on the base of amino acid dihydroxyphenylalanine (DOPA). Such polymer glue retains its properties in water. The web that is glued with the help of this polymer glue can be released after flood. It is useful to made said second prolonged part of web of transparent material, as this adhesive is degraded by light.

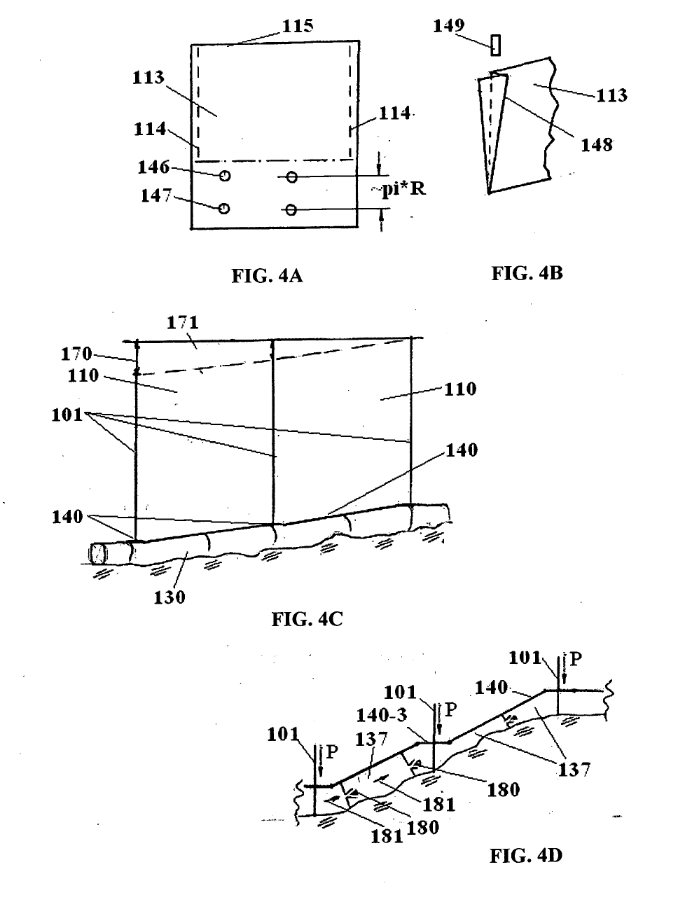

FIG. 4A represents a vertical fragment 113 of the web 110. Such fragments include, for example, zipper tapes 114 (not necessary waterproof) that are allow fast and simply connecting said fragments by forming said web. Such fragment is comfortable to store and can include an upper zipper tape located on the upper edge 115 that allow growing the height of said portable barriers. The openings 146 and 147 are intended for said front member passing (146 from below said sleeve, 147 from above, “R”—the radius of said sleeve). This is useful by the uneven ground. FIG. 4B shows how the bend 148 allows using the rectangular web 113 in the case of the ground surface is roughness. The external clamp 149 allows fastened said bend 148 if this bend is place on the top edge of said web 113. Similar lower bend (it isn't shown) can be fastened by said limiter. Said high flexible thin sleeve can be covered with hydrophobic an/not high-adhesive material.

FIG. 4C illustrates a view of said portative barrier inside. The front members 101, the sleeve 130, the limiter 140 and the web 110 are shown. The extensive element 170 allows increasing the height of said barrier compensating the terrain surface roughness. The additional piece of web 171 can be fastened to main web 110 using zipper or high adhesive covering not shown) and can be fastened to the front members using clamps or other means. FIG. 4D shows the features of using said sleeve filled with water (only!) located on a hillside. The vertical water column pressure inflates the sleeve at the bottom part, reduces the filling of the upper part, and weakens the resistance to leakage. To avoid reduction it is necessary either to increase the pressure in the sleeve, or to divide said sleeve, or at least its part designed to placed with the hillside into the sections 137. FIG. 4D shows said front members 101 (“P” denotes the pressure to the outside parts 140-3 of said limiter). The valves 180 prevent the movement of water down. The arrows 181 show the movements of water for the initial filling.

The proposed portable barrier is compact during storage, inexpensive, easily can be assembled by one person. The first variant FIG. 1D does not require any ballast. At the crucial moment is often impossible to find ballast as quickly as it is necessary. Just enough to bury said anchored blocks previously. The socket belonging this block can be closed with a folding or unscrewing cover. Said portable barrier can surround a house, an area, a building located on a plain and protect against water flood up 1 meter in height. The second variant (FIGS. 1E-1F) doesn't require preset buried anchored blocks and uses any ballast, ballast comprising different pieces having different shapes and sizes.

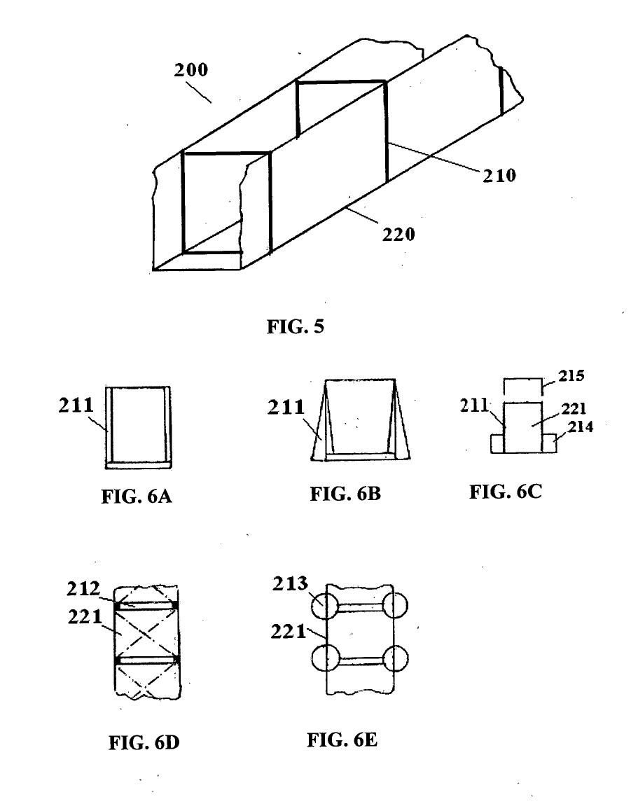

A quick-installable barrier (FIG. 5) is intended for protection against 1-2.5 meters flood water. It allows weakening strong incoming water flows and protecting areas, buildings and groups of separate houses. This quick-installable barrier comprises a trough-shaped open from above closed-end elongated water-impermeable housing 200 having a rectangular or trapezoidal U-shaped cross-section. The bottom and walls of said housing are covered an envelope 220 that is made from a water-proof strong material and is attached to a sequence of equidistant located quadrilateral rigid frames 210 of the same cross-section and made of reinforced plastic or metal tubes or beams of special profiles. These frames can be made from tube filled with water under pressure. The envelope is fastened to said frames 210. The internal space of said housing is intended for filling with heavy ballast chosen from the following group, including: sand, soil, pulp, wet sand, cement, concrete, gravel, sandbags, or their mixes. FIG. 6A represents a cross-section of said housing 200 through said frame 211. FIG. 6D represents a top view of said barrier without ballast (the frame 212 and a bottom 221 are shown). FIGS. 6B and 6E represent other embodiment of said barrier, wherein said frame 213 are made in the form of tube-shaped frames filled with water under pressure. FIG. 6C represents a more stable embodiment. The supports 214 allowing reducing a volume of ballast are shown. The envelope can surrounded said supports, but not necessary. An insert 215 allows increasing the height of said barrier.

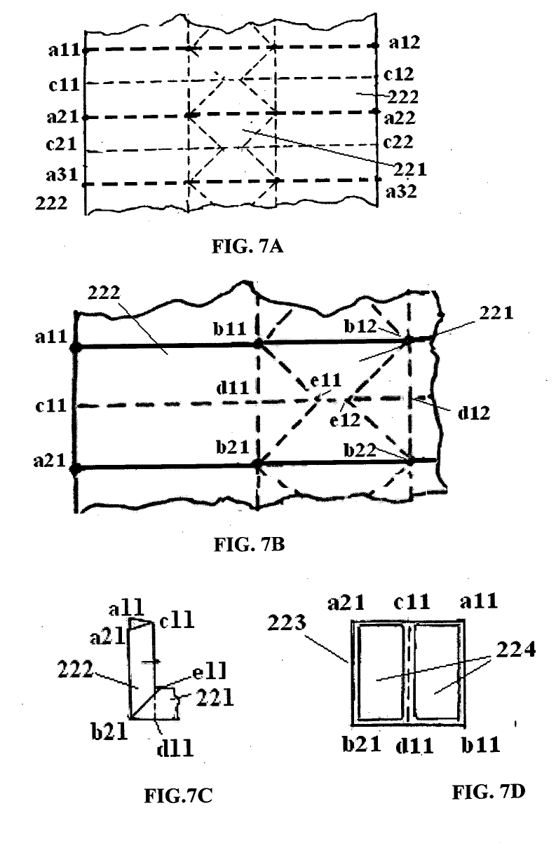

FIG. 7 illustrates how the possibility of folding said barrier. FIGS. 7A and 7B represent lines of the fold; these lines are shown as dotted lines on the walls 222 and the bottom 221 of said envelope. The internal space of said housing is sectionalized into equal sections (FIGS. 7A and 7B). The longitudinal length of said sections is not more than the width of said housing. Further, said envelope is partitioned into groups of said sections by said frames, each of said group includes “N” adjacent sections, where: N=1, 2 . . . , where: N—the natural number. These sections can be separated from each other by flexible or inflexible continuous aprons. The horizontal lines a11-a12, a21-a22, and a31-a32 are separating lines that separate adjacent sections from each other (d) and correspond to said frames (the case of N=1). FIG. 7B shows an enlarged fragment of FIG. 7A. The lines b11-d11-b21 and b12-d12-b22 separate said walls from the bottom (b). The lines c11-c12 and c21-c22 are cross midlines (a) of corresponding sections. Said envelope of the housing 220 can be pleated using said dotted and said think lines, but so that said think horizontal lines all, a21, and a31 have to remain immovable. FIG. 7C illustrates conditionally the scheme of folding. A central segment e11-e12 is formed by two vertexes e11 and e12 of the right angles of the triangles b11-e11-b21 and b12-e12-b22. When approaching to each other said frames a11-b11-b12-a12 and a21-b21-b22-a22 said central segment e11-e12 lifts, the points d11 and d12 come nearer, said triangles b11-e11-b21 and b12-e12-b22 are folded around midlines d11-e11 and d12-e12, correspondently, the walls a11 and a12-b12-b22-a22 of this section are folded around midlines c11-d11 and c12-d12, correspondently. The midlines c11-d11 and c12-d12 come nearer to the triangle midlines d11-e11 and e12-d12, correspondently, as shown FIG. 7C. As a result said frames a11-b11-b12-a12 and a21-b21-b22-a2 will coincide. If suppose that the thickness of said frames is equal to 5 cm, and total the thickness of 4 folded walls d11-e11-b11, e11-b11-b12-e12, d11-e11-b21, and b21-e11-e12-b22 has approximately the same value, then each section having the longitudinal length 1.4 m will be squeezed by packetizing in 14 times approximately.

The opposite walls of said housing can be connected by different aprons, for example, cables, nets, or plastic sheets to hold the shape of said housing by loading ballast. These partitions can be located between lateral sides of said frames, or they can connected the opposite walls between said sections if the space between said these adjacent frames-spreaders comprises more than one sections. FIG. 7D shows that said walls (for example, 223) of said housing can be strengthened by reinforcement, by gluing (or by any fastening) inextensible or almost inextensible thin rigid sheets 224, and said walls can be assembled even from rigid panels connected by hinges, but so that they don't interfere with the folds around said foldable lines. The plastic net can be used a concrete as ballast for said barrier of a permanent structure. The package should be prepared in advance (may be even together with removable rails of a n overhead conveyors, in order for the new package can be quickly installed) and further these packages are installed on special trucks that are equipped with the overhead conveyors.

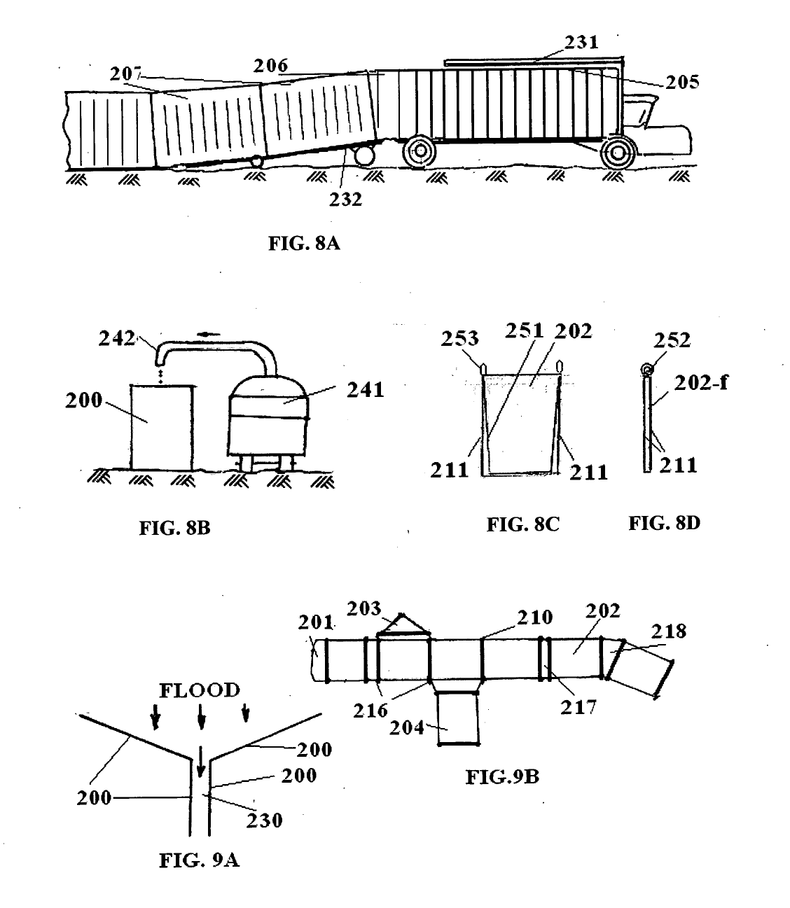

FIG. 8A shows the special truck for transporting said folded barrier and installing it. This truck is equipped with the overhead conveyor and a special inclined truck bed-platform. A part of said quick-installable barrier 205 (a group of said sections) is suspended from guide rails 231 of said overhead conveyor. The frames can comprise sliding elements necessary for transporting said package suspended on said overhead conveyor. Other part of said groups of sections 206-207 move along a truck bed 232, whereas a part of said groups had been set up on the ground. The regular section 206 is shown. The installation of said barrier includes the following steps: (1) fixing the frame nearest to the truck cab to the truck by a final cable; (2) fixing the extreme end frame of the extreme section to the output position of said conveyor; (3) anchoring the extreme end frame of the extreme section into the ground (for example, by cable); (4) advancing said truck for the distance equal the longitudinal length of one group of said sections (between adjacent frames), and moving the extreme group of said sections from said conveyor to the truck bed and extending said package; (5) permanent moving said truck, pulling one regular group of said sections after another, moving said group to the truck bed and moving the extreme groups on the ground. The cable that is attached to the cabin creates the necessary tension and allows stretching fully this barrier. Said final cable is released after moving last section on the ground. During this process each extreme frame can be slowed down on the extreme position located on the truck with special grippers (they are not shown) to provide a complete unfolding all sections. Said frames can comprise one or more pins (they are not shown) directed down and fixed along one or more longitudinal lines. Said truck and its truck bed comprise one or more corresponding grooves so that said pins don't interfere moving said sections. These pins can be useful for fixing said barrier on the ground.

The design of said barrier allows increasing the height of said barrier. The frames can comprise special holes made in upper part that allow inserting additional vertical rods or tubes and fixing a strip of flexible water-proof web. The lower edge of said web can be fastened to upper edge of said wall (walls) with the help of zipper, Velcro-like and/or high adhesive covering. The possibility of height increasing allows compensating the roughness of the ground surface.

FIG. 8B shows as a special motor ballast (waste) pumps 241 (that are analogous to known “motor concrete pumps” or “motor waste pumps”) can load the internal space of such sections of the quick-installable barrier 200 that had been installed on the ground with ballast (soil, pulp, flowable, sand, wet sand, cement, concrete, gravel, sandbags, or their mix, or bulk ballast). It uses a special placing boom 242. It is desirable to have the group of said motor ballast pumps that allows loading said ballast evenly and gradually. Automobile transporters can be used additionally for loading sandbags, stones and the like. Since in many cases due the flood is connected with the flooding river, dredges can be used for stockpiling sand and loading said motor waste pumps. This controlled boom allows directly loading the interior of said housing. The proposed design allows realizing a straight line of mounting said quick-installable barriers. For example, if said barrier is located near the river, a working digger loads one after another the motor ballast pumps, which move, unload said ballast and come back to the river for new loading. The barrier can be equipped additionally with special light lamps located on the top edges of each section helping to orient said boom (even automatically). The most popular model uses to boom with a 36, 41 and 48 m. They are completed with high-pumping capacity of 150 nodes and 180 m³/h. Using the modern equipment as a guide we can assume that the rate of installation of said quick-installable barriers can reach 50 meters per hour and even more, i.e. a team can establish the quick-installable barrier at the rate of 1 km per day that is impossible for any other known variant of barriers. FIG. 8C represents a sub-package (bag) 251 that can be embedded inside the unfolded section 202, allowing removing said sub-package together with its contents in the process of demounting, using links 253. FIG. 8D shows the folded section 202-f between said frames 211 and said convoluted sub-package 252.

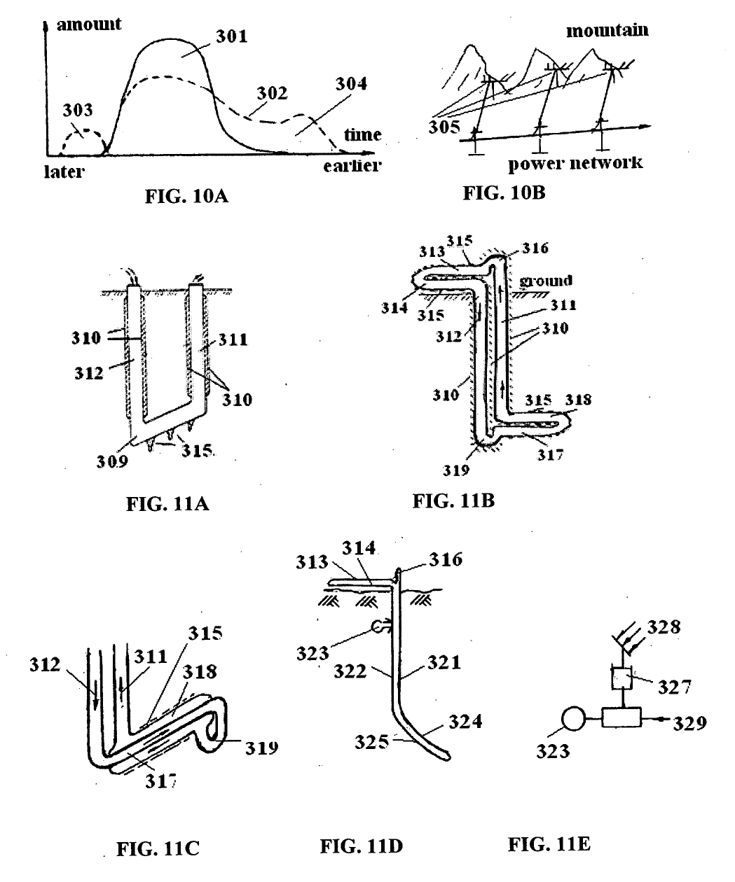

FIG. 9A illustrates removal flood water using the connection of said quick-installable barriers 200 forming through channel 230. FIG. 9B illustrates the possibilities of strengthening said quick-installable barriers and shows a front acute-angled buttress 203 and a back rectangular buttress 204. These buttresses 203 and 204 are connected to said quick-installable barrier 201 by the way connecting corresponding frames. Similarly two quick-installable barriers 201 and 202 can be connected to each other. A unit 217 illustrates the connection of two barriers for creating lengthened construction; a unit 218 illustrates similar connection of two barriers located at an angle. The space between two barriers 217 or 218 can be filled with sandbags, hydrophobic material etc. The quick-installable barriers allow building permanent strong dams using concrete or fast hardening concrete as ballast.

However, even the most powerful barriers and the real quantities available ballast and the real sewer systems (rivers and diversion channels) are powerless before the peak of the masses of water created by natural processes. Therefore, reduction of the peak intensity of the streams of water is the main problem, for the solution of which is the following additional means.

One of the main causes of spring floods is extremely rapid snow melting, especially, close to the riverheads. By posting in these places a lot of heaters can be: (1) in the autumn and early winter to remove a part of the falling snow in the form of melt water, and reduce the amount of accumulated snow; (2) in the cold time occasionally turning on heat causing the melting of the surrounding snow, and then, turning off the heat, allowing freeze frozen water, form of ice masses, which later in the spring will melt significantly slower than the surrounding snow. In addition, by placing the heaters across the expected melt water flows and periodically in the frost turning on said heaters ice barriers can be formed. And these ice barriers will melt slowly and detain a part of the flow of melt water. And, finally, turning on the relevant heaters in the early spring it can speed up the melting of the surrounding arrays. FIG. 10A illustrates these actions. The curve 301 shows the intensity of the melting. The curve 302 illustrates the reduce of the intensity if a part of snow 304 melts preliminary, and another part 303 melts in the delay. The location of these heaters has to take into account the terrain relief. The energy consumption in the very cold winter excessively increases. To decrease the maximum intensity of melt water flows 302 it is proposed with the help of episodic heating to initiate: (1) in early winter—melting the falling snow, reducing its accumulation 304, (2) in the cold—temporary melting snow that allows melting a part of snow for the subsequent freezing and creating dense snow masses of slowly melting ice, and (3) in spring—more early melting of snow 303. FIG. 10B illustrates the ability to control the melting of snow masses. In the mountains there are located horizontal heat exchangers 305 made, for example, in the form of tubes that receive heat from the geothermal devices.

The use of geothermal devices of the self-supporting mode for this purpose is the most economical. The self-supporting device is proposed in our patent RU2064141 (1996, Feldman B. Y., Feldman M. B.)—FIG. 11A (This idea is repeated in T.-H. Yang's U.S. Pat. No. 7,062,911 (2003), JP2005283014 (2005), EP1596139 (2005)). The vertical tubes of ascending heated heat transporter fluid 311 and of descending cooled heat transporter fluid 312 are buried in the ground. At the depth they are connected to each other with the heat exchanger 315, for example, a tube, in which said heat transporter fluid is heated from the heat of ambient ground. Said vertical tubes are insulated 310 from the ambient ground. The different height of these vertical tubes prevents the penetration of the heated fluid (lighter) to the tube 312 and plays the role of one-way valve. The disadvantage is the need of the tilt of used heat exchanger 50-200 meters in length that requires two boreholes and, more importantly, a connecting gallery between them. The new L-shaped self-supporting device is represented Ha FIG. 11B. The notation is the same as in FIG. 11A. The hydro (liquid) traps or siphons 316 and 319 are thermally insulated from the ambient ground, and they as one-way valves prevent from reverse movement of heat transporter fluid. Therefore, the tubes 311 and 312 may be located in the one borehole, but it is desirable that two branches 317 and 318 of the heat exchanger 315 belong to one horizontal plane spaced apart. They may be thermo conductive connected to each other. The space around said heat exchanger has to be filled with thermo conductive filler. There are technologies of inclined (horizontal) drilling (slant drilling, horizontal drilling). Horizontal drilling has long been used in straight pipeline corridors that can't be excavated (highways, take-offs etc.). The temperature increasing weakens the operation of said self-supporting device FIG. 11B, and may even stops it, if the pressure difference, created by the difference of the densities of descending and ascending fluid flows will not be in sufficient to overcome the resistance of entire path. In the case of stopping the temperature in the entire path will be approximately constant. The automatic start of said device will begin then the ambient air temperature falls to necessary value. For this it need the upper valve (liquid trap) 316 and similar upper heat exchanger 313-314-315. To combat against snow, such devices are needed only episodically, but the rest time the circulation of the heat transfer fluid can be switched to other upper heat exchangers that able to use the heat for other purposes, for example for electricity generation and transfer it into common power network, and it is at the frosty periods, when the demands for electrical energy are maximum (not shown). The control of devices can be external, using data on temperature, snowfall and time, but can be and autonomous using the readings of the sensors and hours (it is not shown). The proposed devices can be useful in Polar Regions, in the mountains, etc. They can be used as emergency energy sources in the event of natural disasters, except perhaps earthquakes. It is possible variant when lower heat exchanger can be immersed in water having a constant positive temperature in the cold areas, and especially in those places where the water flow increases heat removal that is limited in the underground. It may be suppose a coaxial variant (FIG. 11C) or the variant (FIG. 11D) using the vertical part of two tube isolated 321-322 of the borehole and an inclined borehole including an inclined heat exchanger 324 and an isolated part 325. The upper valve-liquid trap 316 is necessary, separating the upper heat exchanger 313-314 from the ascending tube 311. The seasonality of work is the feature of said self-supporting devices that is useful for weakening maximum melt water flows and for compensating maximum energy consumption at the very cold time. When this device is used to protect a road (highway) against icing-over it is possible that this icing appears directly after long warm time period. In this it is possible that the motion of liquid delays too long due to the slow convection of cold water in a narrow tube 312(322). Therefore, the little pump 323 (FIG. 11E) is useful 2-3 times per year according to weather forecast signal 329 and can be energy supplied from the storage battery 327 that is charged during to whole year from solar cells 328.

We estimate the parameters of such devices, limited to the turbulent regime, and assuming that the tube material and design shall be such that thermal expansion of tubes in the operating temperature range can be neglected, and the upper and lower tubes heat exchangers represent the equivalent of the same length.

Let us introduce the following notations:

Tg—the temperature of the ground at a depth of H meters (° C.);

Ts—the temperature of the terrestrial surface (° C.);

ta—the ascending water temperature (° C.);

td—the descending water temperature (° C.);

tm—mean temperature (° C.);

g—the acceleration due to gravity (9.81 m/sec²);

Ha≈Hd≈H—heights correspondently of the ascending and descending tubes (m);

L—the length of underground tube, tube-heat exchanging (m);

w—water velocity (m/sec);

ρ—the water density (g/m³);

D—the tube diameter (m);

λ—heat transfer coefficient (ccal/m*h*° C.);

v—kinematic viscosity (m²/sec);

α—the heat transfer (ccal/m²*° C.);

c—the specific heat (ccal/kg*° C.);

P—the pressure (Pa);

Nu—Nusselt number, Pr—Prandtl number, Re=U*D/v—Reynolds number; π=3.1416 . . . ;

Q—total heat transfer (ccal).

At first: the stationary flow requires that the pressure drop caused by the difference of weights of the liquid in said descending and ascending tubes was sufficient to overcome the resistance (using Blasius's law):

ΔP=g*Δρ*H≧0.316*(1/d)*ρ*(U²/2)*{[Ha/Re^{0.25}(5° C.)]+Hd/Re^{0.25}(−15° C.)+2*[L/Re^{0.25}(−5° C.)]}≈0.16*ρ*(U^{1.75}/D^{1.25})*{H[v(^{-0.25})(5° C.)+v(^{-0.25})(−15° C.)]2*L*v(^{-0.25})(−5° C.)};

This implies that:

U^{1.75}<6.25*g*(Δρ/ρ)*D^{1.25}*(1/k)/{[v(^{-0.25}(5° C.)+v(^{-0.25})(−15° C.)]*(1+L/H).

An approximate calculation of the following conditions: Ts=−15° C., Tg=+5° C., ta=+5° C., td=−15° C., D=0.2 m, the heat transfer liquid 30% CaCl₂ that is liquid at the temperature above −50° C.

Correspondently: Δρ/ρ=0.0072; v(^{-0.25})(5° C.)=0.044; v(^{-0.25})(−15° C.)=0.055; k=2;

### Whence L/H=(0.313/U^{1.75})−1;

At second: the length of the lower heat exchanger has to be sufficient to heat the heat transfer liquid:

α*(πDL)*(Ts−tm)>0.25*(π*D²)*U*c*ρ*(ta−td);

where: α=Nu*λ/D; and if U>0.1, Re(5° C.)=0.02/3.776*10(−6)=5260>2300, therefore, the mode is turbulent;

Nu=0.021*Re^{0.8}*Prl^{0.43}*(Prl/Prw)^{0.25}*∈; and let us suppose that ∈=2, then

[Pr(−5° C.)^{0.43}]*[(Pr(−5° C.)]^{0.25}*∈≈11.64;
α=1050*U^{0.8}; c=0.651; ρ=1300; or L=145*U^{0.2};
   at third, the value H has to correspond to the constant positive temperature, i.e. H>15 m. We choose H˜25 m, that corresponds to U=0.2 m/sec and L=106 m. In the case of the horizontal arrangement the length of the horizontal gallery for self-supporting mode should be equal to 53 m.

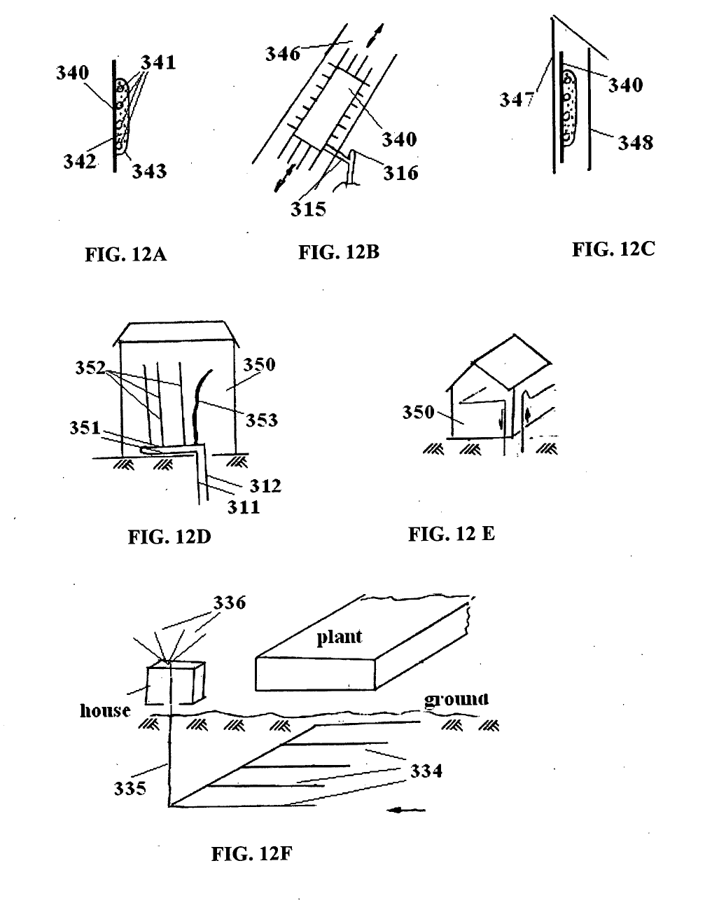

FIGS. 12A-12F represent several variants of the proposed self-supporting thermal L-shaped devices. The high-thermo-conductive plane 340 (FIG. 12B) makes even the temperature field that the heat exchanger 341 made in the form of a coil pipe creates. This coil pipe is covered with high-thermo-conductive layer 342 and closed with isolating cover 343. Such block is placed on road 346, is connected to aforesaid self-supporting device through a tube 315 and said liquid trap 316. The strips 346 help to distributed received heat. FIG. 12C illustrates the use of such device for heating a home wall (347—the internal surface, 348—the external surface). The circulation of the heat-carrier on the floors in the house of 350 can be replaced by a scheme of FIG. 12D, in which the upper heat exchanger 351 (314 and 315) is connected to the rods 352 and flexible trains 353 with a high thermal conductivity, for example, graphite, which carry the heat along the entire object. It is possible to use heat pipes. FIG. 12E illustrates the use of underground heat in a small house. FIG. 12F shows one embodiment, in which the lower heat exchangers 334 are placed under the heat-generating objects, for example, plants. It is known that plants, subways, power plants, and even urban buildings produce enough heat. In this case the flow of underground heat and heat production are summarized. The upper heat exchangers and the converters of heat to electricity located in the “house” connected to the lower tube 335 and 336 are effective at the low temperatures when energy demand increases (of course, approximately).

Another source of water flows are cloudbursts. Typically, rainclouds are moving from sea or large lake to the land and bring water. If too much water, it turns into a terrible disaster, washing away crops and villages, causing loss of life, with its abundance. It is possible two ways to reduce the intensity of water flows: (1) the trigger rain above the sea or lake or (2) to delay of rain, stretching region of precipitation and reducing their intensity in each part of their way.

The heating of the upper part of the raincloud allows delaying the precipitation. This promotes evaporation of moisture, crushing of ice crystals, preventing condensation and expansion of raindrops. In addition, the heating of the upper part of the cloud can help to reduce through melting snowflakes and their transformation into a more easily removable moisture. On the other hand, glaze ice and ice storm forming in the icy rain in the area of warm air front by cold air near the ground surface may be weakened by heating the earth's surface. The same effect can be useful to protect the agricultural against the frost.

These effects require a significant energy source, which can be only Sun. However, the possibility of using solar energy depends on the state of the atmosphere. Cloudy weather may be on the order to weaken the solar flux. Therefore, it is useful to separate the functions of: energy obtaining and its use. It is convenient to receive solar energy at height 20-25 km or above (above the ozone layer, which absorbs UV energy). The force of the wind reaches its maximum at the height of 10 km (30 m/s), to the heights of 20 km it decreases to about 10 m/c, and the wind pressure is relatively low, the air is less dense and the load acting on the structure is 30-40 times. This allows leaving the main clouds with lightning and possible routes of passenger aircrafts and allows the use of airships with an extended surface (of the order of 10E4-10E5 sq m) to accommodate the solar cells. On the other hand, airships having an extended surface is not able to quickly change the height and descend for the exchange of energy, but able to transmit energy or by ray, or to use any auxiliary special transport means.

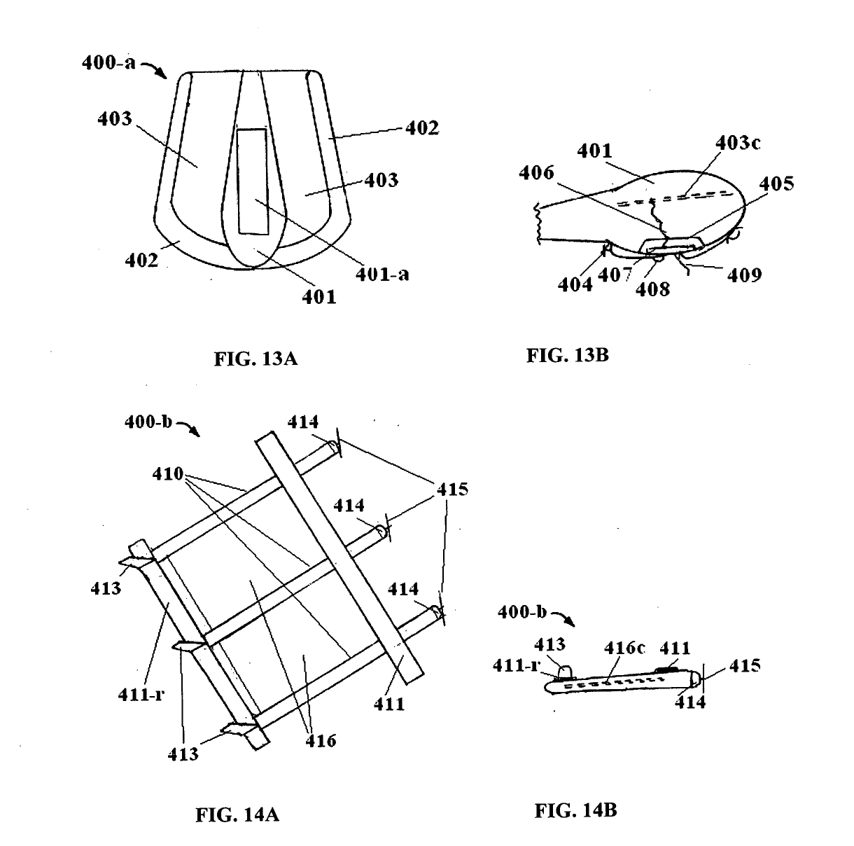

FIG. 13A shows a top view of a dirigible-hybrid 400-a having an extendable surface. A housing 401 comprises main balloon filled with light gas, for example, helium. The housing 401 is connected to lateral ballonets 402 filled with same gas and playing a role of wings. Such design is like to known projects “Stingray”. A light membrane 403 made from thin film or in the form of mattress, covered with flexible from above solar cells and located between said ballonets. At present many types of solar cells suitable for this purpose are known. It is known that depositing a thin film of silicon nanoparticles (one billionth of a meter in diameter) on silicon substrates allowed creating a photo cells sensitive to UV light (Inv. of Illinois) that can be a base for creating wideband solar cells. Multilayer solar cells of a concentrator type are capable to convert UV, visible and IR to electricity. They already now have efficiency up to 40% approximately, and the theoretical limit 87%. The wideband radiation receiver can be made as photo-electrical solar cell or thermo-electrical converter, or a block of multilayer nano-antennas. This dirigible-hybrid can have an aerodrome-space 401-a located on top surface of the central fuselage 401. FIG. 13B shows apparatus attached to said dirigible, comprising one or more electrical engines and propellers 404, a control unit 405, including GPS module, an accumulator 406, cable 406 connected to said control unit 405 and solar cells 403c (that are placed on the membrane 403) and are shows their cross-section), a video camera 408 for control of the position of an unmanned aerial vehicle and a looped-cable air to air recharging subsystem 409. Such subsystem allows quick to charge storage batteries placed on the transport unmanned aerial vehicle (TUMAV), for example, up to 1000 W-h/kg and even 1600 W-h/kg (Fluidic Energy). It s possible that graphene electrodes allow reaching to 15 000 kWh/kg Nano Lett.—2011, 11 (11), pp 5071-5078 ((Ji-Guang Zhang et al). Another variant uses the charge of storage batteries (from discharged battery to charged battery).

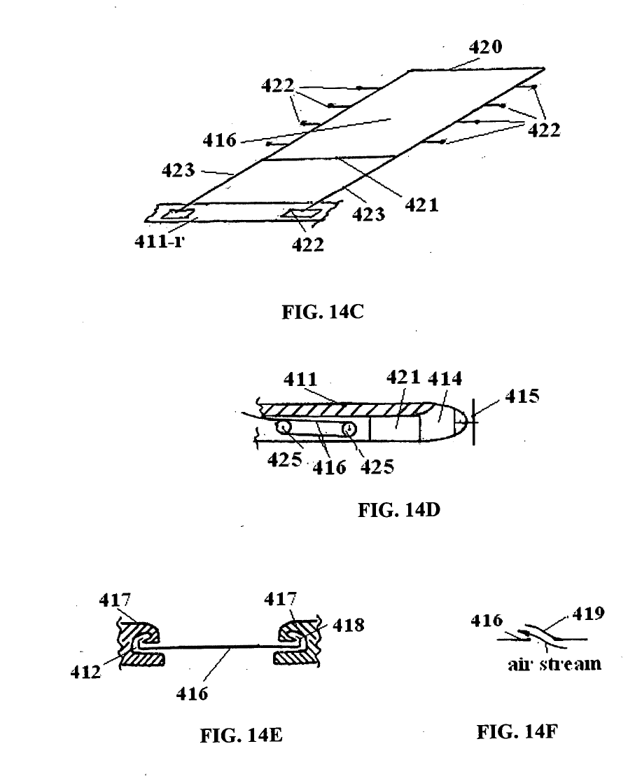

FIG. 14A shows a top view of another (heavier than air) high-altitude unmanned aerial vehicle having an extendable surface (UAVES) 400-b. UAVES can be made in the form of multi fuselages design (for example, two or three fuselages). Shown in FIG. 14A variant includes a front wing 411, three fuselages 410, three electrical engines 414 together with airscrews (screw or propeller) 415, and a tail 413. Such design looks like the project of “Solar Eagle”, but includes a rear wing 411-r that increases a stiffness of construction and improves its aerodynamic characteristics. Two or more strips of a membrane 416 are stretched out between said front and rear wings and/or adjacent fuselages. This membrane can be made from a thin film or a rigid panel. The thin film membrane can have stiffening ribs (not shown) and may be divided the separate strips and can be made with metalized (non-transparent) polyimide (a screening variant). Upper surface of said wing, fuselages and, it is possible, at least a part of said strips are covered with solar cells. FIG. 14B shows a side view of said vehicle. Said solar cells 416c are placed on the membrane 416. FIG. 14C represents a top view of said unrolled membrane 416. The front edge 420 that is fastened inside the wing (to an electrical mini-engine) and the rear edge 421 that another electric mini-engine 422 can stretched with the help of ropes 423. Said engines are built-in into said fuselages or into said rear wing 411-r (FIGS. 14A-14B). FIG. 14D shows one possible variant wherein two rollers 425 are placed under wing 411. The rear engines can help to unroll said membrane 416 in flight and said rollers 425 can roll said membrane 416 before landing. FIG. 14D shows also the location of accumulators 421 between said electrical engine 421 and said reel unit. FIG. 14E shows one variant of two adjacent guides 417 that can be fastened additionally (or are made in the body of) to two adjacent fuselages and that keep lateral edges of said membrane 416 [symbol] ee unrolling after take off. This membrane can be move along said guides 417 inside through slots 412 using lateral sliding elements 418. The internal surface of said slots 412 and external surface of said sliding elements 418 can be covered by materials similar to PTEE or Teflon that has a very low friction even at temperature up to minus 70° C. FIG. 14F shows a notch 419. A plurality of said cuts made in said flexible or collapsible membrane 416 are capable of decreasing the sensibility to abrupt wind shocks “air stream” and stretching said strips. FIG. 14C shows an air flow passing through said notch.

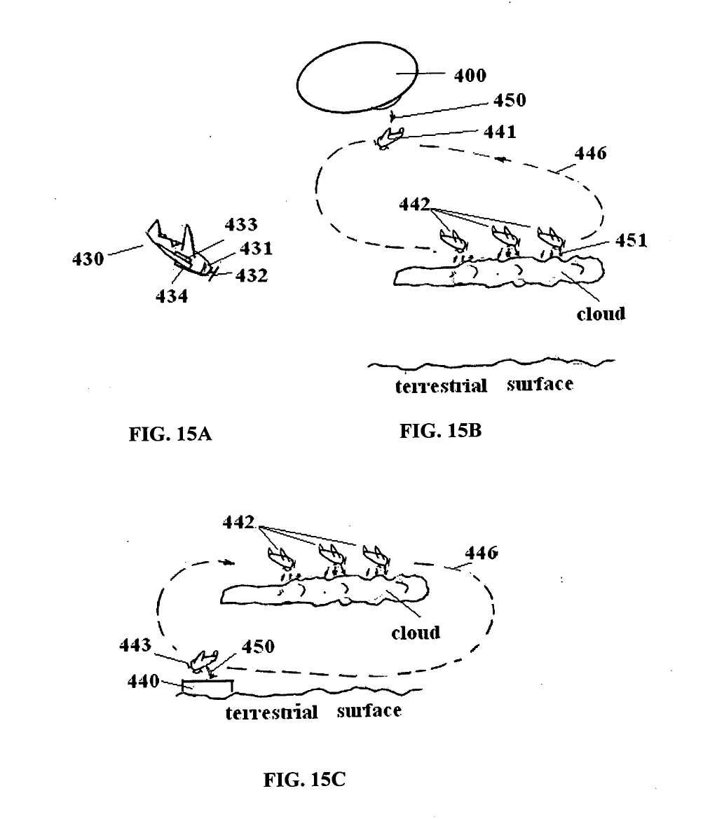

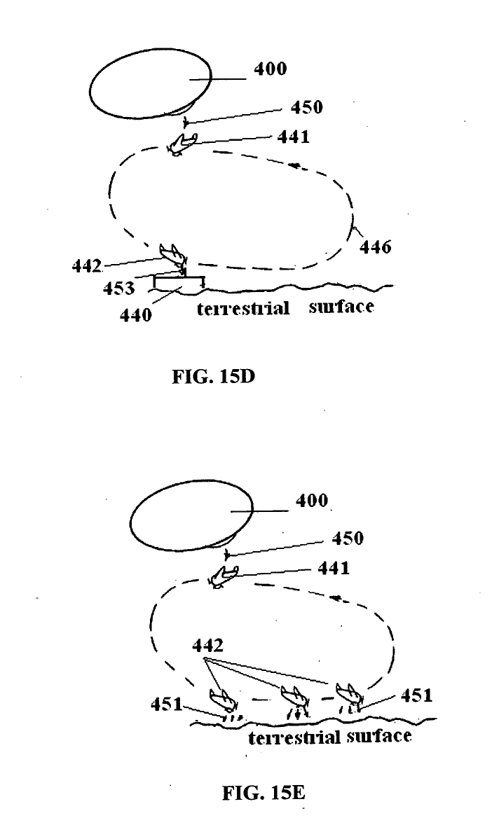

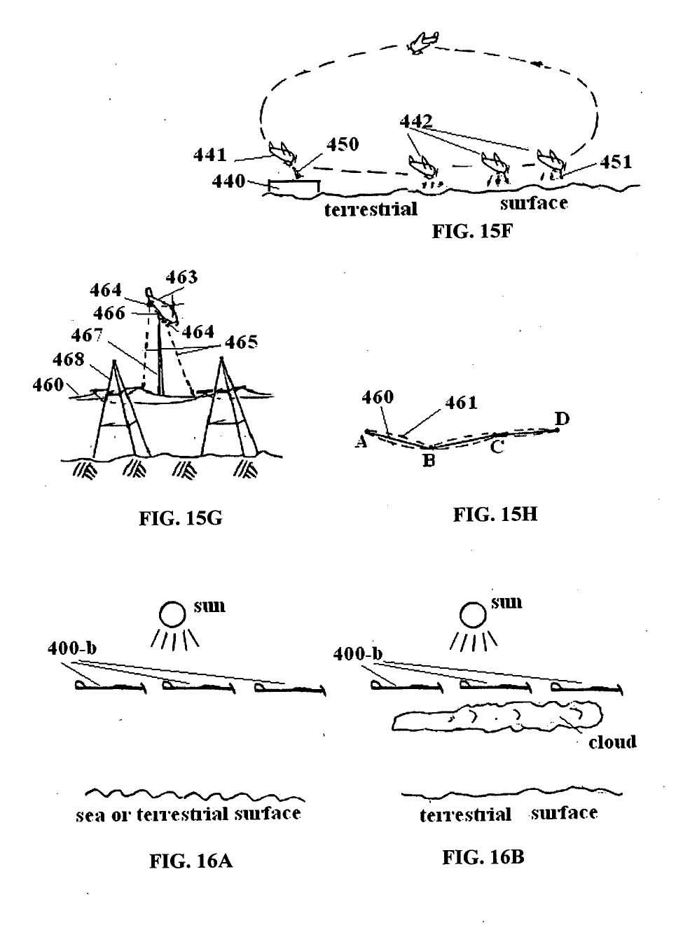

FIG. 15A shows a transport unmanned aerial vehicle (TUAV) 430 that is capable of transporting energy from said dirigible or said UAVES to a ground-based power station or to rain cloud, where it is capable of radiating this energy. This TUAV includes an electrical engine 431, a propeller 432, one or more blocks of built-in accumulator or super capacitor 433 that are intended to supply said engine and other apparatus. Said TUAV can have different embodiments: (1) for energy changing, (2) for heating underlying surface (upper cloud or terrestrial). The second embodiment of TUAV comprises a generator with corresponding radiator 434 (for example, a group of IR laser diodes or a matrix of nano-antennas or VHF antenna), and also an equipment that need for said energy exchanging with said UAVES, for example: a video camera (not shown), and a unit (not shown) in the form of reception cone for a capture of said looped-cable (as one of possible variants) or an extension pylon (further). All said unmanned aerial vehicles must be equipped with one or more modules of GPS allowing defining sufficient the exact position of said vehicles (accuracy of less one meter), as well as special optical and mechanical means of mutual docking. Said UAVES can have three GPS modules that are not lying on a straight line and separated from each other. Said TUAV must be able to fly between the ground station and UAVES, which for this purpose may be to leave said flock and go down to the required height, preferably about 16-20 km. It is possible and lower, but in this case the corresponding UAVES would roll its membrane.

FIG. 15B illustrates a rain delay scheme. The dirigible-hybrid or the UAVES 400 receives sun energy with the help of said solar cells and accumulates this energy in a built-in accumulator (it isn't shown) and after that it (400) transfers this energy 450 to TUAV 441. This TUAV moves along closed trajectory 446 and being in position (TUAV 442) heats the upper surface of shown cloud using IR emission 451 with the help of microwave (VHF) radiators, nanoantennas or laser diodes to evaporate ice crystals to weaken the intensity of water flows. This action may be associated with the use and other known means for this purpose, for example, silver iodide and/or Dyn-O-Gel. After that this TUAV returns 446 for charging to said UAVES 400 along said trajectory.

FIG. 15C represents another variant of such scheme, wherein said TUAV 443 uses energy of a ground-based power station 440. FIG. 15D shows the third variant, wherein, on the contrary, said TUAV 441 receives energy from said vehicle or dirigible 400 and transfers 453 this energy to the ground power station 440.

FIG. 15E and FIG. 15F illustrate additional possibilities: TUAVs 442 fly above the terrestrial surface, such as agricultural crops, and, heating surface, are able to save the crop even in the frost. These TUAVs receive and use Sun energy (FIG. 15E) or energy from a ground based power station 440 (FIG. 15F).

FIG. 15G and FIG. 15H illustrate another opportunity of these TUAVs for de-icing air cables 460 that are fixed to transmission towers 468. The TUAV (a unmanned helicopter) 463 is equipped with video cameras 464 and a radiator 466 (necessary accumulator and generator are nor shown) that are able to form one ore more concentrated thermal beams (for example, IR laser diodes or a matrix of IR nano-antennas). Said video cameras are a part of subsystem (it isn't shown) that can be able to monitor the cable 460, 461, 465 vibrations and to direct said thermal beams to heat said wires 460.

The cloud consisting of said UAVESes 400-b (FIG. 16A) reduces the amount of solar energy reaching the ocean surface, causes a water temperature falling and, consequently, increases CO2 absorption. The average solubility increment depends on many factors, but at normal pressure it can be accepted, as 0.045 grams/liter*degree Celsius. It is known that a surface layer having thickness about meter in a night to be cooled. If in following day the temperature of the layer will not be restored (because of said deficiency of solar heat) then thicker layer will start to be cooled. Let us assume that said layer has 2 meters thick, the temperature of this layer fall off on 5 degrees Celsius (every night only 0.5° C. and in day water temperature has not time to restore in day) and this water layer of a tropic zone. Then the volume of this layer that is equal to 2 cu. m (2000 liters) appropriating 1 qu. m of ocean surface will absorb 0.045*2000*5=4, 5 kg CO2. 10⁸ tons of CO2 or 2*10¹¹ kg require about 10¹¹ sq. m by 30% covering, taking onto account 4 said months, and then, correspondently, it is necessary 2.4 millions of UAVESes having 150*100 sq. m membranes (known “Solar Eagle” has the wingspan of 122 m, and the length of 64 m). The experiments, in which 3D printer was used for creation of “smart” for UAV together with electronic equipment, show that a quantity production is possible. This quantity is not too great if to consider necessity and that annual production of cars (much more complex) exceeding 70 million units. This storage is dynamic, an ocean current carries away this water together with absorbed CO2, there this water can slowly heat up and allocates gas back if said current doesn't leave tropic zone. In the zone covered with said cloud said process of absorption proceeds continuously and if comes new waters it is sated with CO2. In 4 month the summer ends and other period begins. It is really foresaid variants: 1) to create a shadow above the areas of drought and reduce evaporation (FIG. 15G), 2) to create a shadow above the sea surface and lower its temperature, preventing the formation of hurricanes or weakening them (FIG. 15G), 3) to create a shadow above the sea surface and drop it temperature to absorb CO2 the sea surface (FIG. 15G), 4) to create a shadow over the surface of the clouds, to lower its temperature and contribute to triggering rain (FIG. 15H). The height 16-30 km of UAVESes flight allows in advance to see a dangerous cloud and help (perhaps in conjunction with other means) to pour the bulk of rain into the sea. In this case, the upper surface of said UAVESes should be covered with a reflecting layer except for those places where the elements of Solna, or covered nano-antennas, radiating solar energy back into space (in the infrared range).

In addition, such cloud covering a region where hurricanes origin can weaken a hurricane activity. The dirigible having a broad surface, adapted to exchange energy with TUAVs, and flying at an altitude of 10-25 km, has the ability to transmit images of the terrestrial surface as a weather station that allows to see the formation of storm clouds, and can be used as a telecommunication transponder. Said UAVES cloud could be used for screening snow areas in which the melting starts too fast and to protect the ice from melting fields. Moreover, you can create special “list” of orders, which, depending on the time of year are the most dangerous areas. The same group of said UAVESes can be moved from area to area depending on the need.

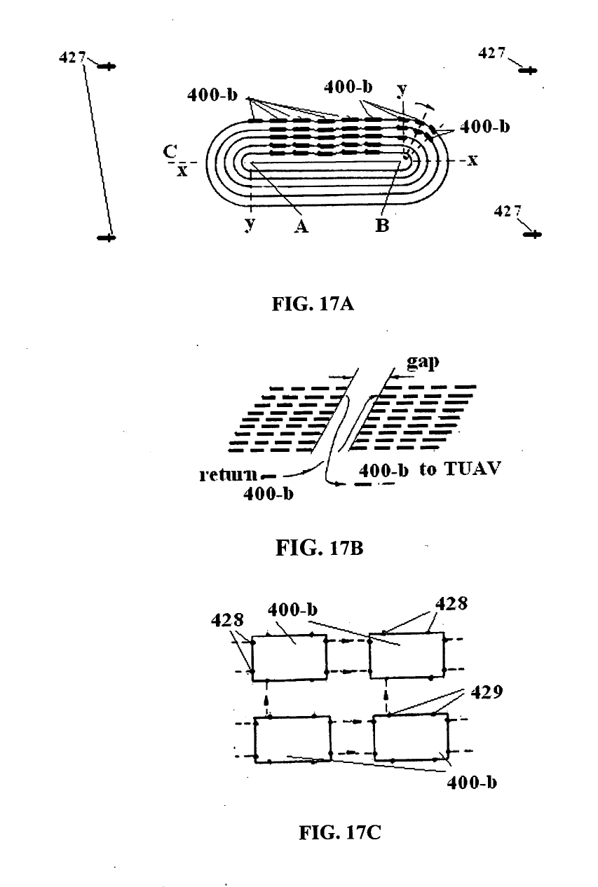

FIGS. 17A-17B represent a cloud-screen formed in the form of a flock that comprises a plurality of said UAVESes 400-b. Said ordered flock formed by said UAVESes 400-b is shown (partially) in FIG. 16A, wherein each said UAVESes 400-b comprises at least 3 GPS modules placed on the two ends of the front wing and GPS module placed in the middle of the rear wing or the tail or the two end of said rear wing. These modules allow defining not only the position of said vehicle, but also its orientation in the plane. Each vehicle 400-b moves along closed concentric air trajectories, located at regular intervals to each other; each said trajectory is geometrical locus equidistant from a line virtual segment AB (FIG. 17A), the length of which is greater than or equal to zero. A plurality of said UAVESes move as group of rows (ranks), row upon row as the ordered flock. Said rows are directed to said segment at fixed angles, and said segment is oriented perpendicularly to the direction to Sun; and the position of each said UAVES in the pack relatively to said segment during its constant motion along corresponding trajectory is recorded in the control unit, and the position of said segment can be change according to predetermined programs or to signals of ground-based station. The modern GPS allows using the distance between adjacent vehicles about 6-12 meters, the perspective modules up to 6 meters and less, and if said vehicle measures 150 by 100 meters approximately then the density may be equal to 50-60%, taking into account empty uncovered space around said segment. This flock must reciprocate, for example, to screen and this space. The known algorithms based on the definition of the mutual location of adjacent vehicles are useless. The use of such algorithms for motion in this flock including many aircraft of this size and at such distances in the conditions of real atmosphere would lead to inevitable collisions. In the case if the density of said flock exceeds a predetermined value, to prevent collisions due to sudden gusts of wind can be used a group of weather plane-scouts 427, flying on different sides of this flock at a certain distance. These scouts inform said UAVESes about sudden guests to allow time for dispersal. In the proposed algorithm each vehicle corresponds to the position of the defined cell of moving coordinate grid. The model of said grid can be in the one or more computer built-in said vehicles and/or in the ground-based station. Said flock includes a gap (“gap” FIG. 17B), free of one or more rows of vehicles to prevent collisions. The change of movements as flock is executed in given order: one after another, one row after another, starting with the head row and the head row starting, for example, from the left. This gap provides a space for maneuver, the parameters of which are limited by the size of the gap. This gap allows said UAVES leaving the flock, for example, to transfer the stored energy to the TUAV, and allows said UAVES returning back to the last row after this process. This is necessary because the process of approaching (see below) of two vehicles for energy transferring also requires a free space. FIG. 17C shows that adjacent vehicles in said flock can comprise light or sound elements 428 and sensors 429 located on the edges of said UAVESes. They allow informing said UAVESes about neighbors approaching and to reduce danger of collisions of these UAVESes.

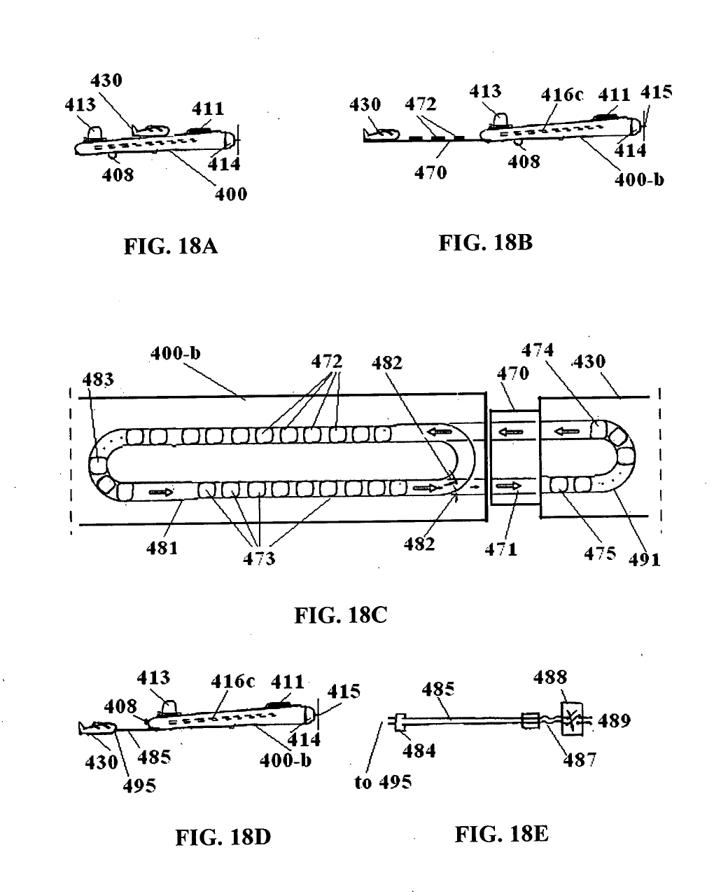

FIG. 18A represents a variant wherein TUAV 430 is able to make a landing on the special flat site located top surface of the based large flying vehicle 400. Said large vehicle can be the dirigible 400-a (like FIG. 13A) or the top surface of the central fuselage of the high-altitude UAVESes 400-b (like FIG. 14A). FIG. 18B represents the second variant wherein said TUAV 430 is docked to main UAVES 460-b with the help of an extensible module (pylon) 470, on which discharged blocks 472 are shown, for example. The proposed system of air-to-air energy transferring uses two vehicles: the UAVES 400-b and the TUAV 430. Naturally, the simpler and more maneuverable vehicle TUAV 430 catches up and is looking for docking, while the more massive and less mobile UAVES 400-b is moving at a constant rate without changing direction. The modern GPS ensure approaching said vehicles to a distance of few meters. Further approaching and docking are performed under control of a computerized system that is connected to the video sensors fixed on the front part of said TUAV and monitoring the light indicators of UAVES. The proposed system of air-to-air energy transferring comprises two possible embodiments. The first embodiment (FIG. 18C) is a bidirectional system using the mutual exchange blocks (storage batteries or super capacitors). Said UAVES that is the donor of charged blocks and said TUAV that is acceptors are docking with the help of the extensible module 470 (FIG. 16B and FIG. 16C). A compound conveyor 481-471-491 comprises three separate parts that are located, correspondently, in the fuselage of UAVES 400-b, on the extensible module 470 and in the fuselage of TUAV 430. The conveyor part 481 comprises a “railroad” switch 482 that has two positions. In flight in the flock said UAVES is able to accumulate solar energy and to charge the block located on the position 483. The blocks 472 are discharged, the blocks 473 are charged. In the first position said railroad switch 482 closes the conveyor 481 in the ring and allows said blocks moving along said conveyor for charging. Each block has a rim (not shown) that holds said blocks in the guides of said conveyor. Said guide lines can have internal grooves allowing moving said blocks step-to-step under the action of pushers using one or two lateral sliding rims (not shown) located in the lower part of said blocks. After docking said railroad switch is switched in the second position and forms a united big ring comprising all three conveyors 481-471-491. In this position discharged blocks 474 from TUAV move through said extensible module 470 to said UAVES and occupy positions 472, and the charged blocks 473 move from said UAVES through the extensible module 470 to said TUAV and occupy positions 475. After undocking the conveyor 481 forms again the closed ring and becomes available for charging discharged blocks. After undocking the conveyor 491 remains stationary.

FIG. 18D and FIG. 18E represent the second embodiment of said system for energy transferring with the help of a device like “flying boom”. A boom 485 fastened to said UAVES and equipped with a plug 484 for inserting into a socket 495 located on the front part of said TUAV 430. An end of the boom 485 where said plug is placed can be equipped with aerodynamic wings (not shown). The socket 495 is placed inside a cone-trap (not shown) for catching said end. A high-current electrical cable is located inside the boom 485 and is connected to said plug. The second end of said cable through flexible (class 5 or 6) cable 487 and through a contactor 488 is connected to an internal power network 489 that is connected to blocks (not shown) located inside UAVES. This contactor 488 can be turn on after confirmed connection between said plug and said socket. Such system is able to transfer only a part of the charge having in the said power network.

The tsunami waves represent the extreme dangerous floods in coastal areas. The last tsunami of 2004 and 2011 years showed the total helplessness of people from this danger. Moreover, there are forecasts based on historical precedents that MEGA-tsunami on the American coast, on the Mediterranean coast is possible. In previous applications referred above the authors proposed to use to destroy the oncoming tsunami the electrohydraulic and/or lighthydraulic dynamic effects that are able to create within the growing wave the tremendous pressure, decomposing water mass into separate parts, and even several drops, causing the increase of their surface, throwing this water mass into the air that greatly increases air resistance and causes the lose of a significant part of energy. However, this stationary version has limited application because it is impossible to protect all the dangerous places and almost impossible to foresee the impact site. The present proposal uses proposed earlier, and significantly supplements it and allows protecting nearly all the coast. It comprises the use a plurality of different rockets to bombard the growing water masses. Using aircraft and for helicopters it is possible to create a mobile system for protecting the coast from the oncoming tsunami waves, as well as to deal with hurricanes.

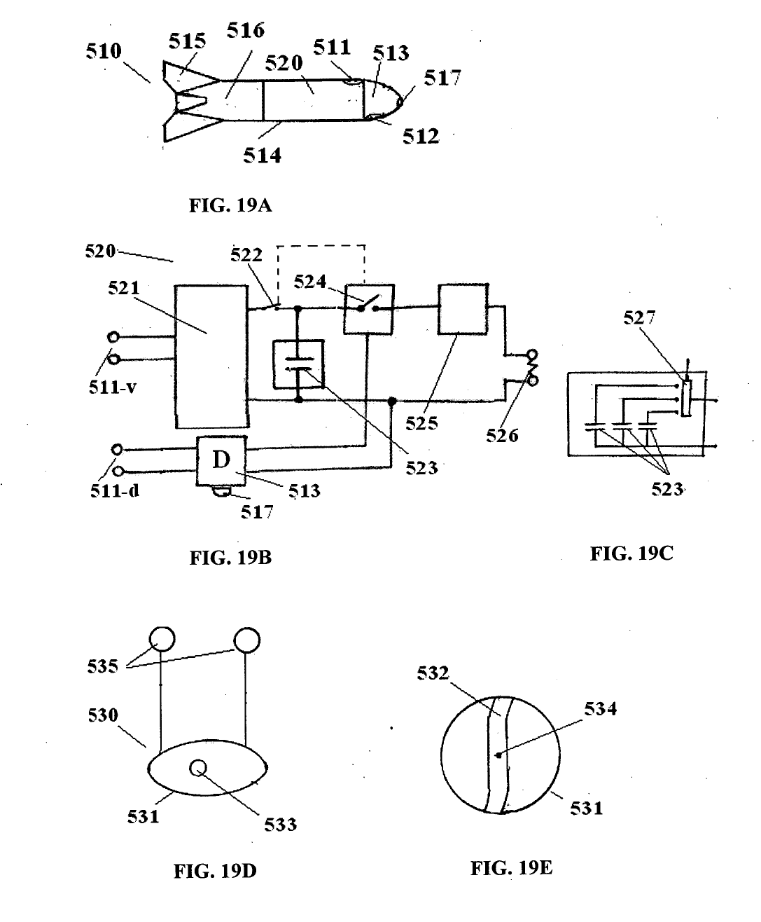

FIG. 19A shows a cross-section of one variant of a special missile 510 intended for delivery of a electrohydraulic generator (EHG) 520 in the area of growing or moving water mass. Said missile 510 includes a housing 514 having a tail 515, an engine 516 (an jet or other types), and a sensor 517 that can be used and that is capable of detecting the time moment of arriving at water surface connected to delay block 513 (FIG. 19B). The spark gap or the conductive element is placed on the housing surface 512 on the dielectric or small thermo conductive area of surface. The socket 511 is intended for charging a capacitor (directly or not) and setting a time delay in the case of external sensor or independently. Said generator (this scheme only as example) 520 (FIG. 19B) includes an input block 521, which through an input 511-v can be connected to an external source constantly or include built-in accumulator or other source (not shown). The block 521 is connected to a capacitor 523 through a key 522. Said capacitor 523 is connected through a turning on block 524 and a forming unit 525 (sharpening front of the signal of the capacitor discharge) to jumper element (or an open spark gap) between electrodes 526. This jumper element 526 is a thin metallic band, wire or a conductive paste for thermo explosion and is placed 512 on the surface of said housing 514 (FIG. 19A) or inside special nozzle (below). This metal jumper (its diameter or width 1-2 mm and in length 20-50 mm) by the capacitor voltage that is equal to several kilovolts (by capacitance of hundreds or even thousands microfarads) that correspondents to 20 or more kilojoules. The thermo explosion of said jumper can produce a hydraulic shock and a cavitations' bubble filled metal-water steam with the pressure of 0.1 or more GPa. This cavity extends sharply and causes moving and exfoliating water mass. The input socket 511-v allowing changing said capacitor 523 before launching this missile and the input socket 511-d allowing setting the delay block 513 are located on the housing surface also and connected to the external sensor 517. The key 522 is used to charge capacitor 523 after start, and after each explosion to create a sequence of said bubbles. Its action is synchronized with the blocks 524 and 513. FIG. 19C shows an implementation of said block 523 in the case if it isn't possible to use only one capacitor. The action of the switch 527 is synchronized with other components 522, 524 and 513.

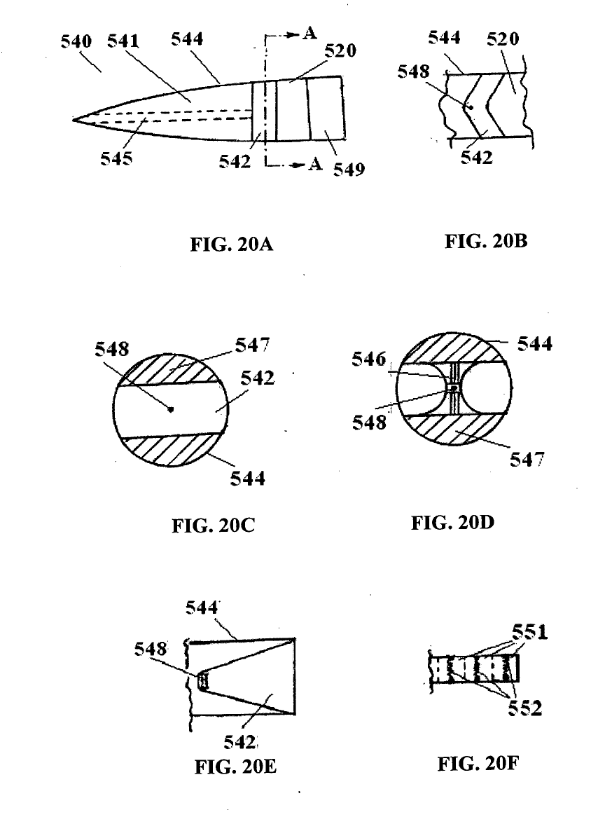

Four types of said missiles can be used for struggle against tsunami and hurricane depending on the parameters of capacitors (weight, size, price) and an additional equipment: (1) simplest missiles (bullets) that are able to generate a single bubble (FIG. 19A); (2) missiles in the form of passive disks that are able to move together with water stream and to generate a few said bubbles (FIG. 19D and FIG. 19E); (3) missiles-torpedoes 530 (FIGS. 20A-20B and FIGS. 20C-20F) that are able to generate a few said bubbles moving along given trajectory; and (4) missiles-torpedoes that are able to generate a plurality of said bubbles moving along trajectory that is defined with regard to the given task and/or the reading of sensor(s).

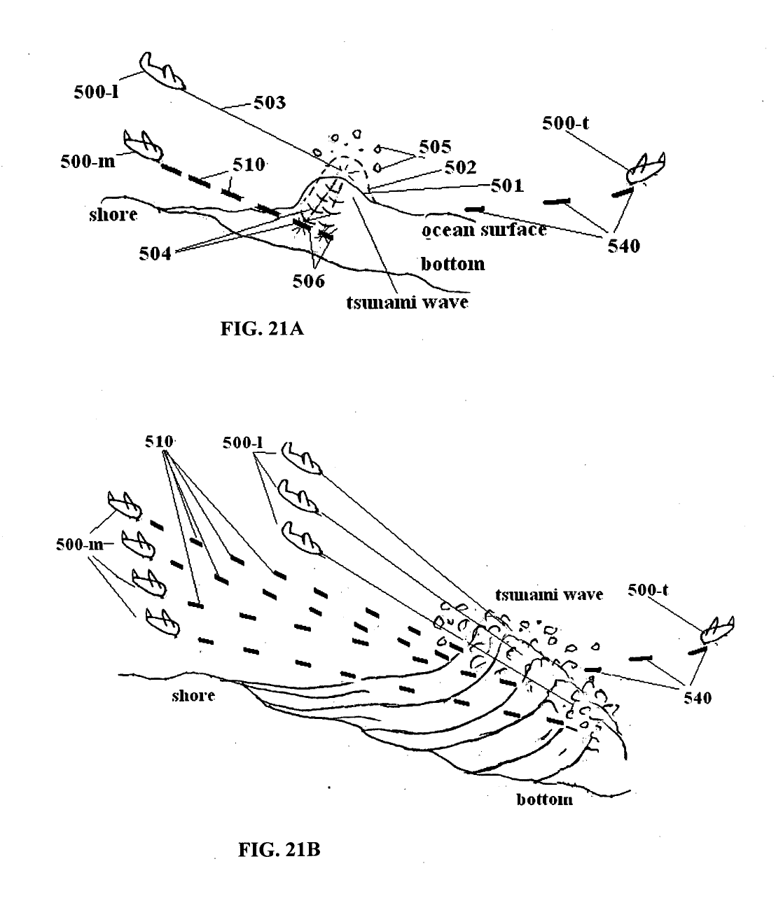

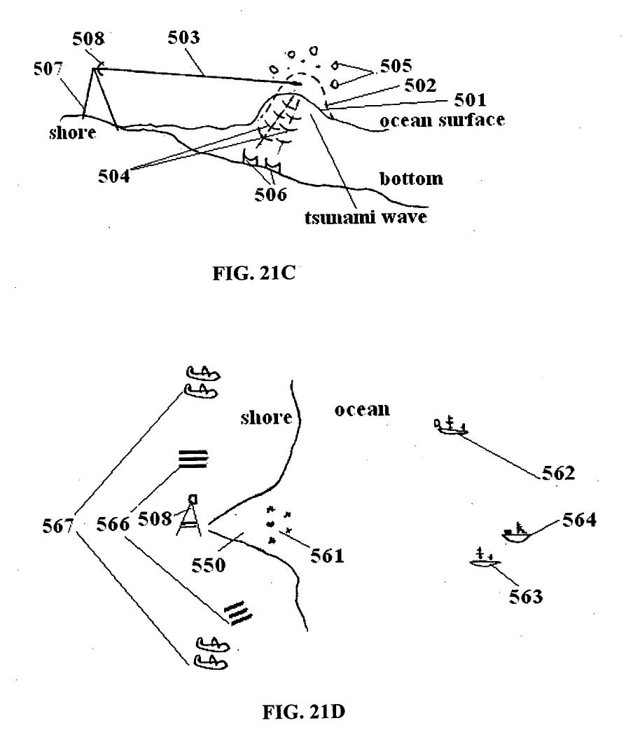

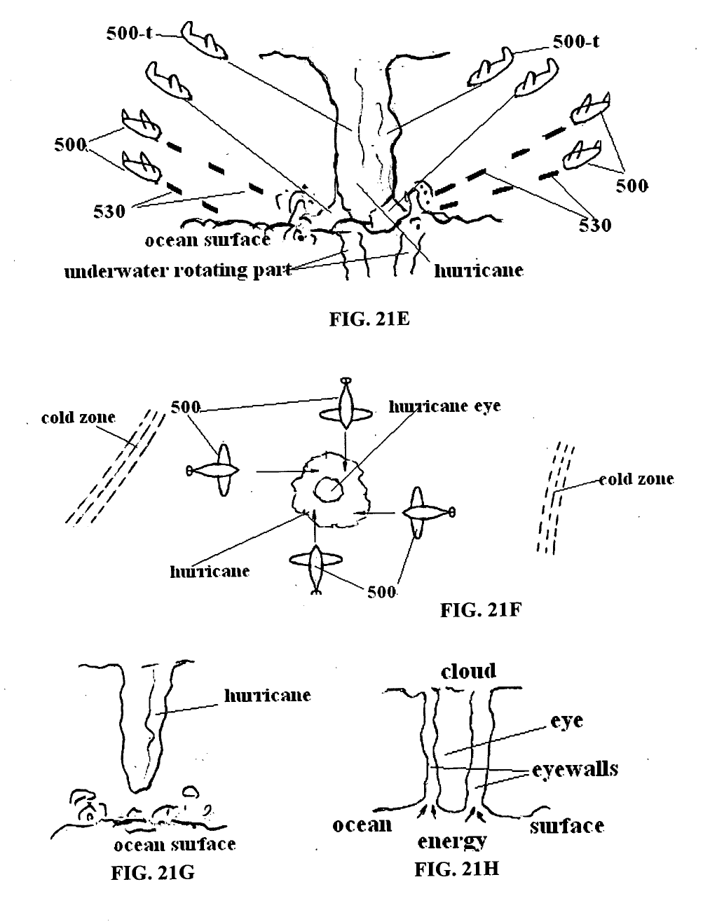

The floating disc 530 is shown in FIG. 19D (a front view) and in FIG. 19E (a top view). Its housing 531 has a form of the disc. Said hollow section 532 can be bent in the direction to its ends 533 that allows creating the rotation of said floating disc and helps to stabilize its position. The shape and orientation of the nozzles can create a rotation of the rocket body and therefore its greater stability. This floating discus 530 is intended for bombing from helicopters or from dive bombers (FIG. 21). Approaching water said discus is moving together with water flow, and time to time said built-in generator generates with the help of the explosive element 534 the bubbles filled with steam of high pressure. The floating discus 530 can be equipped with emitted light enters the water filled with air or steam floats 535 that are able to float on the surface, helping to stabilize the discus position. In addition, said floating discus can have other means inherent said missiles and/or said torpedoes (not shown).

The torpedo 540 (FIG. 20A) can be made in the form of known weapon and comprises an engine 549, EHG 520, and a control block 541 including means for stabilizing the trajectory of said torpedo. This torpedo includes a hollow section 542 having a cylinder form (generally) that is intended for [symbol] spark or [symbol] [symbol] and forming steam cloud. This torpedo can have special hollow channel 545 connected to said section 542 for moving a part of said vapor cloud forward and creating a steam envelope around said torpedo housing 544 that allows increasing the motion rate. The control unit can depend on the complexity of the torpedo and its application area to move forward (for example, together with the wave of the tsunami), or for a given rate around a rotating hurricane trunk. FIG. 20B shows another focusing shape of said hollow section 542. The explosive element 548 is placed in the focus in the bend of said section.

FIGS. 20C-20D represent two variants of a sectional view of said hollow section 542 taken along line A-A (FIG. 20A). [symbol] [symbol] hollow section can be closed by special cover (not shown) during moving said torpedo and can be opened after said explosive. FIG. 20C represents a horizontal orientation of a channel wherein the explosive element 548 is located; two outlet nozzles are directed to the opposite sides and the two vapor bubbles are distributed in different sides in the horizontal direction, exerting the least influence on the movement of torpedo 540. FIG. 20D shows a mechanism 546 for the nomination of said explosive element (wire or tape or paste) and replacement of blown up on a new element (similar to the mechanisms described by L. Yutkin and other authors), but must be individually developed for each design of said torpedo. FIG. 20E represents another view of nozzle 542 and a place of said jumper 548. The strips 551 (FIG. 20F) is intended for moving a group of said jumpers 552

It is possible different combinations, allowing ensuring the long-term work of such torpedoes. It is possible a combination of capacitors and batteries, allowing charging repeat the capacitor (of course, a voltage multiplier). It is possible to use the built-in electro generator supplied with conventional fuels or even nuclear-powered mini-reactor, creating an autonomous submarine, long-term work, which may accompany a hurricane during a long time and all the time weaken its activity.

New researches on Mg/S batteries allowing receiving up to 400-4000 W-hour/kg (1.4-14 MJ/kg) that corresponds to 70-700 bubbles (theoretically by 20 kJ/bubble) are described. Last articles (Z. Xu et al) represents a opportunity of 70 kW-hour/kg (252 MJ/kg) that correspondents up to 600 bubbles even in the case of 5% efficiency factor. Decreasing size and weight allow creating simply, inexpensive and mass production missiles. New developments will allow creating the missiles and torpedoes having the very successful parameters. In particular, U.S. Pat. No. 7,033,406, Weir R D et al and EEStor (USA) promise to create capacitors with voltage up to 1.2-3.5 kV and having a capacity of up to tens of farads. The PVDF-based capacitors using rotational mechanism have good prospects for high energy density and high discharge speed.

The growth of said wave gives a few minutes only for this process against tsunami. It is necessary to create a plurality of bubbles filled with steam of high pressure. Each of missiles can create during this time period no less than ten bubbles. It is necessary to reach such size and weight that allow producing about up to 10-100 thousands of said missiles. Hurricanes aren't limit said time.

The implementation of said missiles on the base of EHGs there is a problem with the sizes and weight of modern capacitors. To create sufficient bubbles filled with high pressurized steam the capacitors having a capacitance from several units microfarads to several thousands by the voltage up to several tens kilovolts and very short current up to several kiloamperes. There are different ways allowing reducing these requirements, in particular, the use of thin ribbon made from Al, an explosive of which causes the decomposition of water according to following reactions:

3Al+3H2O->Al2O3+6H,

Al+H2O->Al(OH)3+3H.

The hydrogen is formed and a heat is released as result of these reactions. The resulting hydrogen is developing additional pressure that is added to the plasma pressure (Cortckondzhija V. P. et al). Another way is connected to previous saturating using metal with the hydrogen (Grigoriev A. N. et al). Decreasing size and weight allow creating simply, inexpensive and mass production missiles. New developments will allow creating the missiles and torpedoes having the very successful parameters. In particular, EEStor (USA) and Zenn (Canada) (U.S. Pat. No. 7,033,406, Weir R D et al)) promise to create capacitors with voltage up to 1.2-3.5 kV and having a capacity of up to tens of farads.

The proposed protective system against a tsunami requires a timely warning about the expected wave of rapid and timely creating in given area the necessary means that can weaken the oncoming one, two or three tsunami waves. There are currently developing systems allowing detecting earthquakes and landslides, and also the rapid alert system (in the Pacific and Indian Ocean they use the instruments and submarine cables (NOAA). New developed algorithms can provide (http://eco.ria.ru/discovery/20111004/449193225.html) information faster than moving the tsunami, and this makes possible not only to give the public warning of the need to leave home, but also to enact the proposed defense system, making it effective. The analysis of GPS-signals distribution in ionosphere caused by the rise and fall of tsunami waves allows a half-hour and more ahead of the tsunami attack determining the risk, the direction, and the place of growth wave, preparing the effective protection, and weakening tsunami waves. In parallel, the mobile or stationary means for this purpose can be created on the shore, as well as a group of underwater generators in the most dangerous areas.

The protection against tsunami includes creating a plurality of duty aircrafts (helicopters), a part of which must be equipped with the necessary number of special missiles, and some equipped must be equipped with the power lasers. These flying means after receiving a signal about tsunami and calculated information about place of the expected arrival of waves emitted to attack.

The attack should be made taking into account the fact that the laser beam penetrates to a limited depth. The turbidity of the water contributes to a more severe reaction, but limits the depth. Said missiles can penetrate more deeply, and therefore they must act in a deeper layer. Combining these tools with other known and taking into account the bottom topography and the parameters of the oncoming wave is possible to achieve the strongest effect.

FIG. 21A illustrates the destruction of the growing crest of tsunami waves (hump) 501 by laser pulses 503 that are created by a laser (not shown) mounted on an aircraft 500-1 (It may be a jet, able quickly to reach the dangerous area, and/or a helicopter that can hover above the growing wave). It is known the “Airborne laser” in USA. A lighthydraulic effect destroys the wave 501, spraying water in the form of drops 505 and forcing at least a part of water mass to move from water to air and back losing energy. The ruby or neodymium laser can be used. Various impurities—gas bubbles, sand, and paint particles—scatter the light and become centers of local heating boosting this effect. Such opacity or turbidity may be created, for example, by an explosive or said electrohydraulic shock wave generator 520 mounted on the airplane 500-m. This figure shows the possibility of combined impact using two sources: (1) shock pressure 504 created by the explosion of said missile 520-e (see US Pat. Appl. 20100150656—FIG. 21C), pushing out a lot of water in the air 502, and (2) said laser that destroys this water hump spraying 505 and depriving it of the accumulated energy. A group of said generators 506 may be placed on the bottom. The torpedoes 500-t can be launched by airplane 500-t and can move together with wave or even ahead of it. These torpedoes may be made in the form 530 shown above or in the form of floating discus 540 (FIG. 19C).

The more turbid the water, the more said lighthydraulic effect, but the smaller the depth of the beam in the water. On the other hand, the preset value of the delay (511-d and 513) allows, using said engine 516 to produce an explosion at a predetermined depth. This combination makes the most efficient to work on tsunami wave for its destruction. Moreover, they allow you to find and destroy not only the first wave, but the second, which can be very strong, and the third.

FIG. 21B illustrates [symbol] [symbol] [symbol] [symbol] . It is useful to use [symbol] [symbol] [symbol] [symbol] [symbol] [symbol] [symbol] stationary similar system_{b1} (U.S. Ser. No. 12/930,433) located in more dangerous places. FIG. 21C illustrates a stationary system. The laser 508 is located on the tower 507. Its ray 503 acts to the top of tsunami wave, and the bottom electrohydraulic generators 540-e act from below as it is shown in FIG. 21A. It can be useful another direction of the attack. The missiles can be directed along the wave crest that lengthens the possible way of said missiles and prolongs their action.

FIG. 21D represents a scheme of the “deference” against tsunami. A convergent bay 550 can focus the tsunami wave coming from ocean. Such bay must be underwater electrohydraulic generators 561 as it is shown on FIG. 21A (506) and ground based tower 508 having a laser device as it is shown on FIG. 21C. These means are stationary protection against tsunami. On the shore the ground based batteries 566 of said electohydraulic special missiles (FIG. 19A) are placed. Airdromes of aircraft 567 that are equipped with laser devices and/or said special missiles are distributed along said shore so that they can reach the predetermined air position required for the attack against the waves as quickly as possible. In addition, in the ocean boats (vessels) 562 and 564 equipped with said lasers and said special missiles or both devices 563 simultaneously.

FIGS. 21E-21H illustrate the use of said systems against a hurricane. It is important to break energy pumping from the warm surface water to weaken the hurricane. FIG. 21E and FIG. 21F (a top view) show the formation of possibly more whole continuous ring consisting of said bubbles filled with steam of high pressure breaks the connection between the hurricane trunk and the warm ocean surface and the energy supply of said hurricane. The impacts to the hurricane should be made on all sides to cut off completely as possible from the hurricane surface layer of the ocean-energy source. The laser equipped aircrafts 500-t fire the vertical hurricane or tornado trunk directly preferably in the thinnest part of this trunk using laser waves in the range of water absorption. FIG. 21G shows in the case of loss of energy source a hurricane (FIG. 21H) is gradually disappearing. It is important to try to create a more complete ring of said bubbles under said eyewalls. Unlike the tsunami to weaken a hurricane have to act a long time. Therefore, it is the most useful the torpedoes of last two types. It is desirable that torpedoes of fourth type would move in a circle on the walls continuously creating steam bubbles. The acoustic sensors, pressure sensors can be used for orientation, but, unfortunately, it doesn't known that occurs under a hurricane. Thus, the torpedo can cross the line of the foot eyewalls, navigate, for example, by radio or visual, and again cross the foot eyewalls continuing to generate bubbles, and repeat this procedure several times.

It is desirable to combine this process with other known methods of struggle, for example, creating cold zones (FIG. 21F), using Dyn-O-Gel, or creating with the help of rockets filled with FAE through holes in the hurricane (or tornado) trunk, or causing a pressure difference to weaken the stability of said trunk.

The increase of the intensity of natural phenomena (except seismic and technological disasters) is associated with a Global Warmer and increasing concentration of CO2 in the atmosphere. One of the perspective methods for reducing CO2 concentration in atmosphere is the intensification of CO2 absorption by organisms living in the ocean and using CO2 for their skeleton, primarily corals. An atmospheric carbon dioxide (CO2) is in dynamic equilibrium with CO2 dissolved in the ocean.

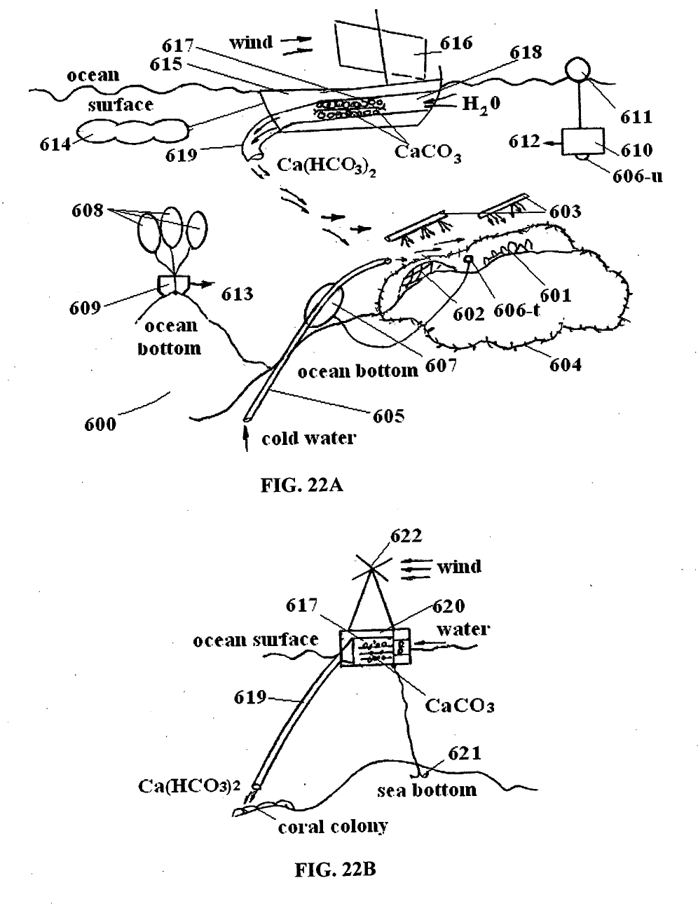

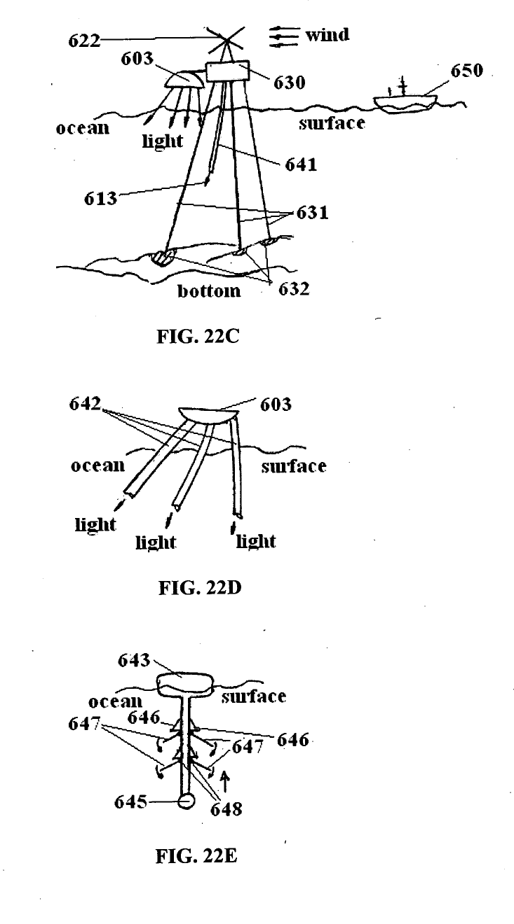

Ha FIG. 22A represents the proposed scheme of an underwater “pseudo-aquarium” 600 for coral colony. Said “pseudo-aquarium” comprises a natural coral colony 601 and an artificial coral colony 602 surrounded by a protected wire or net 604 against [symbol] [symbol] [symbol] [symbol] [symbol] [symbol] and can be illuminated by luminescent lamps 603, housings of which have not high temperature (˜60° C.) or other light sources having low temperature. A long conduit 605, a lower inlet of which is dipped into a deep cold water layer, an upper outlet is located nearly said colonies. A temperature sensor 606-t controls a pump 607 built-in into said conduit 605 and allows keeping cool water nearly said colonies 601-602. It is possible to use a control unit 610 including necessary additional sensors 606-u (pH, chemical composition, etc.; really, this system is a part of complex monitoring system like NOAA system) and able to inform a central station and to receive corresponding command signals 612 with the help of a floating antenna 611. Said control unit 610 may be a separate unit or be built-in into the vessel 615. This “pseudo aquarium” 600 includes a electrical power unit 609 that uses wave energy and can provides 613 said protected wire 604, illuminated lamps 603, the water pump 607, the thin frame of artificial colony 602, and said control unit 610 with electrical power (connecting cables aren't shown). This power unit 609 can be made like one of following devices: upwelling stations Power Buoy (Ocean Power Technologies), BioSTREAM (Bio Power) or any other using alternative energy (wave energy, wind energy etc.). Said metallic wire or net 604 connected to electrical source 609 and additional illumination 603 allow protecting against starfishes that hunt at night. The conduit 605 intended for supplying said coral colonies with cold water rich by organics.

Two processes take place in said coral colonies: (1) coral skeleton forming in the process of calcification; (2) CO2 absorbing in the process of photosynthesis that takes place in the body of seaweed Zooxanthellae that live in symbiosis with corals.

The experiments in an aquarium showed that photosynthesis and the associated with it a respiration and calcification in the light were 25% more if the water moves around the colony at a rate of about 20 cm/sec. Physiological activity of coral skeleton formation depends on the temperature. An optimal boundary lie within 25-27° C. Below or above the photosynthesis weakens, and with it lime deposition reduces (Arutyunov VS, Inst. Chem. Phys RAS). It is known, that absorption atmospheric CO2 in ocean surface layer falls with growth of surface temperature and grows by hashing of said layer (Am. Sc. 7-90 2-91). It is known also, that ability of absorption increases with increase in water stream speed and its turbulence. The positive result is known at use of an electric current for coral restoration (Pemuteran Coral Reef Restoration Project, 2001, Indonesia, Northwest Bali, Wolf Hilbertz and Tom Goreau). Researchers (O. Levi, Queensland) found that sexual excitement associated with the corals, these corals feel moonlight (blue light) through the protein able to respond to this light. Consumption by symbiotic seaweed of carbonic dioxide during photosynthesis rises on the order speed of calcination, shifting balance of reaction of formation CaCO₃ from Ca (HCO3)₂, and it leads as collateral consequence to accumulation and adjournment CaCO3, i.e. to skeleton forming (Schuhmacher, Arnfried, 1976). Speed of zooxanthellae photosynthesis is directly proportional to speed induced by light calcination of coral (Chalker, Taylor, 1978). Speed of calcination in darkness is in 2.6 times below, than by light. 1980).

The change of some external conditions to allow increasing a speed of skeleton construction of corals. Consumption by symbiotic seaweed of CO₂ during photosynthesis rises on the order speed of calcinations, shifting balance of reaction of formation CaCO₃ from Ca (HCO₃)₂. It leads also to accumulation CaCO₃, i.e. to skeleton formation (Schuhmacher, Arnfried, 1976). The positive result is known at use of an electric current for restoration of corals (Pemuteran Coral Reef Restoration Project, 2001, Indonesia, Northwest Bali, Hilbertz W. and Goreau T.) and artificial growing corals (Japan). This “Karang Lestari” technology accelerates growth of corals in five-ten times and does by their steadier to aggressive influence of an environment. The small electric current submitted on underwater trellised metal designs as shown in FIG. 21A (602) is sharply accelerate process of increase of the calcareous connections, being a nutrient medium for corals.

[symbol] [symbol] [symbol] [symbol] [symbol] [symbol] [symbol] [symbol] , [symbol] [symbol] CO2 [symbol] [symbol] seaweed in the process of photosynthesis: 6CO₂+6H₂O+light energy->C6H₁₂O₆+6O₂ The use of all important additional means that allow significantly accelerating both said processes, but this acceleration is limited by lack of calcium concentration in ocean water. For this purpose it is offered to use the following process: CaCO₃+H₂O+CO₂=Ca (HCO3)2 that transforms insoluble calcium carbonate CaCO3 to soluble hydro carbonate Ca (HCO3)2, which is easily digested by said seaweed zooxanthellae. The calcium carbonate is widely distributed in nature, is widely used in industry, annual production of the calcium carbonate is equal approximately hundreds of millions of tons.

FIG. 22A further represents a variant of calcium delivery to said coral colonies 601-602 with the help of a plurality of special vessels 615. Said vessel 615 includes a replacement cartridge 617 filled with crushed limestone CaCO3. This vessel includes also a through level channel 618, through which ocean water H2O passes, interacts with said limestone, and runs out enriched in Ca (HCO3)2 through a branch pipe 619 or special long hose in direction to said colonies. Said vessel can be unmanned, have a sail 616 and use the wind energy for its moving and producing electrical energy using a wave energy converter, like, for example, to “Anaconda” (Arctic Global Co) 614, for supplying a control and navigation unit (not shown). After using said cartridge its replacement by new one can be execute either in seaport or using special transport vessels (not shown).

FIG. 22B shows other variant (a fragment), wherein said cartridge 617 is located inside floating module 620. This module 620 is fixed by anchor 621 and receives electrical energy with the help of wind generator 622 mounted on this module 620. FIG. 22C shows another variant (a fragment), wherein a module 630 including said cartridge (not shown) is fixed to ocean bottom with the help of pylons 631 that are fastened to bottom ground 632. The wind generator 622 supplies an external light source 603 (this light source isn't involved with temperature limits) with electrical energy and other equipment through cable 641 instead of 609 (FIG. 22A). The fixed module 630 requires certainly a special transport vessel 650 for delivery and replacement said cartridges filled with said CaCO3. FIG. 22D shows more one variant (also only fragment) wherein an artificial lighting said coral colonies is executed through light guides 642 directly to necessary places. FIG. 22E represents a device for descending water flows forming allowing moving a CO2-rich surface ocean layer downwards to said coral colonies. This device comprises a float 643 connected to a vertical rod 646 that is ended with a weight 645. Rigid planes 647 are capable of swinging up/down on hinges 648. When float 643 moves up following wave then said planes 647 fall. When float 643 moves down following wave then said planes 647 push apart, rest against the stops 646 and push CO2-rich water mass down in the direction to said coral colonies. This device can be controlled by the way of fixing said planes in the lower position. For this purpose the float 643 must receive corresponding command.

While the invention has been described in connection with specific and preferred embodiments thereof, it is capable of further modifications without departing from the spirit and scope of the invention. This application is intended to cover all variations, uses, or adaptations of the invention, following, in general, the principles of the invention and including such departures from the present disclosure as come within known or customary practice within the drilling art or as are obvious to persons skilled in that art, at the time the departure is made. It should be appreciated that the scope of this invention is not limited to the detailed description of the invention hereinabove, which is intended merely to be illustrative, but rather comprehends the subject matter defined by the following claims.

We claim:

1. An advanced protective system against dangers caused moving water masses, comprising a plurality of protective barriers and additional means intended for actions against the natural processes that are responsible for the formation of dangerous water flows;
said protective system, wherein said protective barriers are intended to hamper water flows being installed in their path and said additional means are intended to weaken said water flows during the process of their formation and mainly to prevent as far extremely strong water flows as possible;
said protective system, comprising at least one of the following two types of barriers: a portable barrier, intended to protect separate homes against flood water up to 0.8-1.0 meter; a quick-installable barrier, a housing of which has a rectangular or trapezoidal cross-section and filled with heavy ballast to protect areas and homes against more severe and higher flood water;
said protective system, wherein said portable barrier comprises:
(1) a palisade, consisting of extended up and slightly slating back front members that are spaced evenly approximately around a protected object, and lower ends of which are adapted for mounting to be fixed to pre-buried anchor blocks or front bearing plates, and such that middle part of each said front members rests on two supporting members forming a tripod, and lower ends of said supporting members lean on rear pre-buried anchor blocks or bearing plates or blocks equipped with recoilless bearings;
(2) an elongated impermeable web that closes said palisade in front and that is characterized in that its lower part curves backwards, prolongs further back and lets go pass the lower parts of said front members through openings in said prolonged part;
(3) an elongated sleeve, single or double, filled with water, air or flexible filler, located on said prolonged part of the web from above, located closely along said palisade and including a plurality of through vertical and slight slating back channels, not violating its leak-proofness and located according to said front members; and
(4) an elongated limiter located on top of said sleeve so that all said front members pass through openings in said limiter and said sleeve;
said portable barrier, wherein said prolonged part of said web is made from as possible as flexible impermeable material connected to the rest of said web and covered with high adhesive layer or hydrophobic cotton-like, depending on soil properties, and in the case of the use of said front bearing plates these plates are located on said prolonged part.

2. The system according to claim 1, wherein said portable barrier comprises said sleeve made in one of the following forms: (a) sample cylinder, (b) single cylinder including said vertical through water/airtight channels for passing corresponding front members, (c) double sleeve consisting of two closely located cylinders and connected with each another;
said sleeve, wherein said cylinders have elastic envelopes that are filled with water or air under pressure or resilient rubber-like filler, or are made in the form of flexible rubber-like cable, and wherein said connection of two or more said cylinders is made by gluing, welding or using an enveloping thin continuous or fishnet stocking, retaining for said front members the ability to let pass between said cylinders through a set of through channels;
said portable barrier, wherein said limiter consists of a set of flat or slightly convex upwards sections connected with each another, each of which has preferably two through openings near their ends and two hinges near said both openings, but closer to the middle of said section;
said limiter's sections, wherein said hinges are in the form of mechanical components or in the form of the flexible components glued to adjacent parts of said sections, connecting these parts with each other and allowing bending said sections to compensate roughness of terrain surface;
said portable barrier, wherein said sleeve being located on said prolonged part and said limiter located on the top of said sleeve are configured so that each said front member passes through corresponding channels in said sleeve and corresponding openings in said limiter.

3. The system according to claim 1, wherein said portable barrier comprises means pressing each section of said limiter against the top surface of said sleeve, and said means are chosen from following: nuts screwed on each said front member during said barrier mounting or heavy ballast loaded on special triangular or quadrangular platforms during said barrier mounting;
said portable barrier, wherein said platform has two possible implementations: the first implementation is characterized in that said platform is a metal, plastic or wood plate, the second implementation is characterized in that said platform includes a metal, wood or plastic frame, on which a slightly extensible or inextensible web is stretched;
said portable barrier, wherein said plates or said frames are leaned on: (a) one or two washers slipped over one or two adjacent front members and pressed to corresponding sections of the limiter and (b) two the adjacent rear blocks;
said portable barrier, wherein said rear blocks and said platforms are configured so that, being loaded, said plates and said webs stretched on the frames do not touch the terrestrial surface;
said portable barrier, wherein said means press said limiter against said sleeve so that said sleeve in turn forces said prolonged part of said web against terrestrial surface, compensating surface roughness and prevent to water infiltration from below.

4. The system according to claim 1, comprising said quick-installable barrier and wherein said quick-installable barrier comprises: a plurality rectangular or trapezoidal strong narrow frames and a sectionalized envelope that is divided into equal sections by said frames so that the longitudinal length of said sections is not more than the width of said barrier and that is fastened to said frames made from metal or plastic tubes, or bundles of said tubes, or special profiles;
said quick-installable barrier is characterized in that said sections located between each pair adjacent frames are able to be folded in the form of a compact package, and so that lines of the fold are: (a) cross midlines of said sections; (b) common lines of said walls and said bottom; (c) lateral sides of two right-angled isosceles triangles belonging to the bottom of each section and having its triangle base as common lines of said walls and said bottom; and (d) separating lines that separate said adjacent sections from each other;
said quick-installable barrier, wherein said walls and said bottom are made from material, chosen from the following: (1) inextensible waterproof plastic; (2) inextensible waterproof plastic, wherein at least a part of the surface of said walls and bottom between said lines of fold is reinforced with hard plastic, metallic or ceramic, so that reinforcing elements do not interfere with said folds; (3) waterproof hard plastic, metal or ceramic sheet connected by waterproof hinges along said lines of the fold and don't interfere with said folds;
said quick-installable barrier, wherein said bottom in specific cases comprises sheet made from metallic or plastic net that do not interfere with said folds;
said quick-installable barrier is characterized in that, being folded, each said section forms a compact package according to said lines of folds, and for this purpose said barrier configured to elevating the segment connecting two vertexes of the right angle of said triangle relative to the bottom plain that causes in its turn folding each said section in two by lower surfaces to each other and pressing to each other.

5. The system according to claim 4, comprising one or more special trucks equipped with an overhead conveyor intended for said quick-installable barrier transportation and mounting, as well as additionally motor means for transporting and loading said ballast; said quick-installable barrier that being in the form of said package suspended on said overhead is configured for:
(1) fixing the extreme rear end frame to said truck near a cabin of the truck;
(2) anchoring the extreme front end frame to the ground with a cable or other means;
(3) advancing said truck for a distance equal to the longitudinal length of one group of said sections between adjacent frames, and moving the extreme group of said sections from said conveyor to the truck bed and stretching (unpackaging) said package;
(4) maintaining said process of moving said truck, pulling out one regular group of said sections after another, moving said group to the truck bed and moving the extreme groups on the ground, holding down the rear end frame to the truck cabin until stretching all barrier stops;
(5) releasing said cable and moving rear sections and said extreme rear frame to the ground so that all said barrier will be unpacked and stretched on the ground;
said system, wherein said additional motor means to ensure the quick loading the housing of said barrier from above comprise: one or more auto transporters or motors with ballast pumps that are equipped with a ballast placing boom; said transporters or motors are capable of moving one after another between source(s) of said ballast and said barrier, and further along said sections that have been installed already on the ground, and said transporters or motors pumps are adapted for filling said sections in predetermined order with a heavy ballast chosen from the group, including: sand, soil, pulp, wet sand, cement, concrete, gravel, sandbags, flowable, or bulk ballast, or their mixes;
said system, wherein each said section is that are adapted to include one or more sub-packages of full height, suitable for removal and open to the filling from above and having a total volume equal to said section volume.

6. The system according to claim 4, wherein said quick-installable barriers are adapted for connecting to each other and characterized in that at least a part of lateral struts of said frame include connecting elements that connect said frame with each other so to create elongated and/or strengthened protective structures;
said quick-installable barriers, wherein said lateral struts include fastening means placed on the top ends of said struts and allowing increasing the height of corresponding frame and fastening additional strips to the upper edge of corresponding envelope.

7. The system according to claim 1, further comprising one or two groups of said additional means intended for actions against the natural processes that are responsible for their formation dangerous water flows to decrease the height and to weaken the intensity of said water flows, mainly to weaken maximum of said intensity, and, correspondingly, to increase the efficiency of said protective barriers and said protective system;
said system, wherein said first group of said additional means intended for weakening processes of formation of huge water masses in the places where said water masses are formed and begin their moving, and said additional means of said first group are chosen from the following means:
a) a plurality of geothermal devices having elongated tubular heater located on a terrestrial surface or inside a surface layer in areas of snow masses and configured for reducing the intensity of melting water;
b) a plurality of unmanned aerial vehicles having at least in-flight an expanded upper surface (UAVES), configured in the form of an ordered flock consisting of closely-spaced said vehicles moving along closed given trajectories so as to form a sufficiently dense screen, and said screen flying above: (1) rain cloud, saturated with moisture and dangerous by the subsequent flood on land, to protect against sun rays for promoting the formation of ice crystals as centers of condensation and triggering rain in the necessary place chosen from: above ocean to prevent flooding on land or more safer area of land; (2) ocean area in the zone of dangerous latitudes where the temperature exceeds the allowed value and said hurricanes arise to reduce the temperature of the ocean surface, to weaken the hurricane danger and to increase CO2 absorption;
(c) a plurality of missiles, each of which is able to generate one, several or a plurality of bubbles filled with high pressure steam and which launched into surface layer of the high-speed moving water mass in the area of growing hump of tsunami or a lower part of eyewalls of hurricane so that said a plurality of said high pressure steam bubbles could smash said water mass into separate parts, disrupting energy transfer between water layers and inducing energy loss due to mutual collisions and additional air resistance;
said advanced protective system, comprising above said barriers and said additional means either separately or any combination depending on necessity, natural and weather conditions and technical and economical opportunities.

8. The system according to claim 7(a), wherein each of said geothermal device comprises: (1) an elongated upper heat exchanger located on terrestrial surface or inside surface layer in areas of snow masses; (2) an elongated lower heat exchanger located at a predetermined depth; (3) two elongated impermeable tubes covered from the outside with a heat-insulating layer and connecting input of each of said upper and lower heat exchangers to output of another; (4) a thermo-carrier liquid that remains liquid in the necessary temperature range and fills the interior of said tubes and said heat exchangers forming a through continuous channel; and wherein each of said geothermal device is made in the form of one of two following implementations: (i) the geothermal device, in which said tubes are located inside one or two vertical or inclined boreholes, inlets of said heat exchangers are connected to corresponding tubes through liquid traps, and the length of said tubes at given parameters of said lower heat exchanger and said heat transformer liquid is sufficient in order to keep up a self-supporting movement of said thermo-carrier liquid at given negative ambient temperature; (ii) the geothermal device, in which a special pump involve the forced movement of said heat thermo-carrier;
said geothermal device of the second implementation, comprising a controlled unit allowing turning off and turning on said pump or switching the flow of said head thermo-carrier liquid from said upper tubular heat exchanger to another heat exchanger according to an external signal from a timer, thermometer or the like; and further said geothermal device of the second implementation comprising said controlled unit and configured to initiating the melting of falling snow in early winter and/or in early spring, and/or initiating snow melting in winter that contributes to the subsequent freezing of melted water and forming dense ice masses.

9. The system according to claim 7(b), comprising a plurality of said UAVESes, flying along closed given closely-spaced trajectories at common height in the range of 16-30 km in the form of an ordered flock forming a sufficiently dense screen above one of the following areas: (1) a predetermined area of ocean to reduce or to prevent a hurricane dangerous and to increase the CO2 solubility; (2) a predetermined area of land to preserve moisture and vegetation in arid areas; (3) a predetermined area of lakes to reduce evaporation and to maintain a water level; (4) a predetermined area of rain clouds to promote ice crystals formation for moisture condensation and triggering rain over: ocean areas reducing the amount of moisture transferred to the continent, or land areas where detriment caused with flooding is minimal, or where moisture is needed;
said system, wherein said UAVESes are characterized in that: their upper surface is able to reflect or absorb sun, rays falling on said upper surface; and wherein each of said UAVESes comprises at least one thin long wing, to which one, two or more fuselages including fails are fastened symmetrically relative to said wing middle, one central or two or more symmetrically located fuselages include electrical engines with propeller attached from the front or back, one or more energy accumulating blocks, consisting of storage batteries or super-capacitors, and that are able to provide round-the-clock work, a computerized control and navigation unit including more than one GPS modules fixed to construction of said UAVES and allowing defining the position of said vehicle in space;
said UAVESes, wherein a space between said fuselages is closed at least in-flight with a rigid structure as said wing or in the form of one or more thin film strips; said strips are able to be rolled inside said wing using electrical mini-engines or unrolled and stretched in-flight using aerodynamic elements located on said strips or similar mini-engines;
said UAVESes, wherein the top surfaces of said strips and/or said fuselages are covered with plurality of solar cells, and said solar cells are connected to said blocks, that are connected to said engines and mini-engines and said control and navigation unit;
said system, wherein said UAVESes are able to fly as an ordered flock along closed concentric air trajectories, located at regular intervals to each other; each said trajectory is a geometrical locus equidistant from a line virtual segment; said plurality of UAVESes are able to move as a group of rows (ranks), said rows are directed to said segment at fixed angles, and said segment is oriented perpendicularly to the direction to of the Sun;
and the position of each said UAVES in the pack relatively to said segment during its constant motion along a corresponding trajectory is recorded in the control unit, and the position of said segment can be change according to predetermined programs or to signals from ground-based station.

10. The system according to claim 7(c), wherein each of said missiles intended for struggle against tsunami or hurricane comprises a sealed streamlined housing and one or more electrohydro generators (EHGs) that are located inside said housing and capable of generating bubbles filled with high pressure steam as a result of spark discharge between output electrodes or a burning of thin metal jumper under water that is pressed between said electrodes;
said system, wherein said missiles are chosen from the following types:
(1) simplest missiles (bullets) that are able to generate a single bubble;
(2) passive missile-disks that are able to move together with water stream and to generate a few said bubbles;
(3) simple missile-torpedoes that are able to generate a few said bubbles moving along given trajectory;
(4) missile-torpedoes that are able to generate a plurality of said bubbles moving along a trajectory that is defined with regard to a given task and/or signals from sensor(s);
said missiles-torpedoes comprise a control unit connected to an engine using separate propulsive agent or recoil as a result of bubbles generation;
said system, wherein said missiles comprise: (a) sensor(s) of, chosen from the followings: pressure, time delay (timer), acceleration, or temperature, defining at the moment of landing on water's surface; (b) said EHG, using said thin metal jumper for steam bubbles generation and comprising an automatic unit to change the burnt jumper as it is burning; (c) said output electrodes are located in a nozzle built-in into said housing for missiles of 2-4 types and so that the recoil after the generation of each bubble would be compensated or directed along the longitudinal axis without disrupting the direction of missile's movement.

11. The system according to claim 10, wherein said attack against the growing tsunami's wave comprises acting separately or jointly: (1) a plurality of missiles launched from the different sides, from the front, from the rear and along tsunami wave, to the area of the surface layers to create one or more layers of said bubbles, horizontal and/or transversal, weakening the energy transfer between adjacent water layers and causing a loss of energy caused with the collapsing bubbles; (2) a plurality missiles launched to the surface layer of tsunami hump and/or laser rays acting on this hump and, especially, to its front part so as to break the flow into a plurality of droplets to push out to air, causing them to lose energy to overcome air resistance.

12. The system according to claim 10, wherein said attack against high-speed water flows of hurricane comprises: a plurality of missiles launched from different sides at a tangent to the lower part of eyewalls to create as possible a continuous stream-air ring in the foot of eyewalls preventing an energy transfer from warm water to the hurricane trunk;
said system, wherein said attack of said missiles can be combined with laser ray strikes on the base of the light hydro shock effect and/or explosion of FAE allows to increase the process of said bubbles' creation in near-surface and surface water layer of the hurricane;
the laser rays are intended for steam bubbles' creation on surface, and said missiles—in more deeper water layers; and
wherein the trajectories and parameters of said missiles and zones of said laser rays' actions are chosen so as to weaken the energy of water layers and to reduce the energy transfer from layer to layer.

13. The system according to claim 12, wherein said torpedo comprising a built-in fuel or mini-nuclear power generator, allows ensuring long-term acting of said torpedo and providing a long-term action of said EHG; and wherein for creating said steam bubbles' ring said torpedo is configured to execute one of the following series of steps: the first series: circulating under said eyewalls in concordance with a given program with regard to the reading of acoustic or pressure sensor(s); or the second series: (1) moving at a tangent to the middle line of said eyewalls, (2) defining own position after leaving from hurricane, (3) turning to the hurricane, and (4) repeating this series beginning from (1) many times.

14. The system according to claim 7, wherein the second group of said additional means that are intended for the weakening of the Global Warming and, correspondently, the intensity of dangerous natural processes, using the intensification of CO2 absorption and weakening ocean acidity, includes a plurality of unmanned stations;
said system, wherein each of said stations includes a longitudinal through channel equipped with controllable lids on one or both sides, inside of said station with latticed cells filled with limestone heap are placed; said stations are realized in one of the following implementations: (1) robot-ships equipped with navigation tool, controlled by wind sails and energy sources; (2) robot-ships laid at anchor near coral colony; (3) the stations mounted near a water flow; said system, wherein each of said robot-ships comprises said design, allows that sea water that flows through said channel in the course of said ship moving and open lids to convert said insoluble limestone to soluble bicarbonate according to the following reaction:
CaCO3+H2O+CO2=>Ca(HCO3)2, absorbing CO2 that is dissolved in sea water;
each of said robot-ship uses a plurality of solar cells located on the ship deck and/or a wave energy converter floating astern as said energy source, and that are able to provide the movement of said robot-ship and power supply a control unit and the GPS module; said system, wherein said unmanned robot-ships are configured for:
(i) mooring to the shore near the base of the limestone accumulation;
(ii) loading with limestone said latticed cells with closed said lids;
(iii) moving the given area near coral colony;
(iv) arriving at a given area and opening said lids;
(v) cruising in a given area, forming said bicarbonate and dissolving said bicarbonate in sea water for weakening calcium deficit;
(vi) after processing the whole limestone closing said lids and returning to said base; said system, wherein given area is defined by analyzing the content of calcium in se a water near coral colonies, where said calcium deficiency is a result of an intensification of coral growth.

15. The system according to claim 14, comprising for said increasing the intensity and the reliability of burial of CO2 by the way of absorption and burial by natural underwater skeleton creating breathers, mainly coral, a plurality of devices for directly intensification of the growth of coral, located in area of coral colonies and chosen from followings: illuminating devices, temperature controlling devices, water current controlling devices, electrical current wire frames, which carries electrical current, compensating the calcium deficiency caused by the use of means that intensify coral growth, including: (a) a plurality of distributed devices for protecting against sea-stars on the base of metallic wires through which the electrical current traverses; (b) one or more wave water converters allowing supplying energy to said devices.

16. The system according to claim 14, wherein the resulting bicarbonate is used for a collection of the resulting bicarbonate in closed rear lid, a decomposition of the resulting bicarbonate inside closed reservoirs using solar energy, and using resulting CO2 for the subsequent synthesis; said stations being located offshore, such an arrangement allows using of the coastal water flows, facilitating the supply of the limestone, and transporting the resulting CO2 of the increased concentration.

17. A system for an ecological safe energy collection, accumulation and distribution, comprising: a first plurality of unmanned aerial vehicles with extended, at least in flight, surface (UAVESes) and intended for flying over a long period of time at heights of 16-30 km and a second plurality of transport unmanned aerial vehicles (TUAVs);
said system, wherein each of said unmanned aerial vehicles includes:
(a) one or more energy accumulating blocks, including of storage batteries or super-capacitors, capable of providing: (1) a long-duration round-the-clock flight of said UAVES accumulating collected energy, and (2) flights of required duration of said TUAV for receiving said energy from said UAVES and transporting received energy for direct use or distribution; and (b) means for air-to-air energy transfer from said UAVES to said TUAV;
said system, wherein each of said unmanned aerial vehicles comprises one or more electrical engines and propellers, a computerized control and navigation subsystem including one or more GPS modules (no less than two for UAVES) fixed to surfaces of said vehicles, a vision subsystem joined with a navigation subsystem and autonomous flight control subsystem to establish and maintain a required relative location of corresponding UAVES and TUAV during said energy transfers;
said system, wherein each of said UAVESes comprises: a thin long wing; one, two or more fuselages fixed to said wing symmetrically relative to its middle; one central and/or two or more symmetrically located electrical propeller engines fixed to the fuselages from the front or back; said fuselages include also tails and are joined by a common long horizontal rear boom (wing) forming one or more frames; a space between or around said fuselages is closed with a rigid wing-like structure, or one or more thin film strips; the front sides of said strips are fixed to folding devices located inside the wing between corresponding fuselages, and either rear sides of said strips are fixed to said boom with thin tightened cables connected to rear folding devices, or lateral sides of said strip are hooked inside adjacent fuselages with the help of sliding elements; and wherein said folding devices are connected to electrical mini-engines allowing folding and unfolding said strips, and wherein said UAVESes are characterized in that a upper surface of said structure and/or said strips is covered with plurality of solar cells that are connected to said blocks that are connected to said engines, said control and navigation unit, and said mini-engines;
said system, wherein said TUAVs are used as the transporter-intermediary from UAVESes collecting solar energy and are equipped for one of two purposes:
a) for an energy transfer from UAVESes to special ground-based stations;
b) for an energy transfer from UAVESes to a land area to protect agricultural plantations against frosts or to a cloud to delay triggering rain by way of melting ice crystals as centers of condensation;
and wherein said TUAVs are able heating these land area or cloud during to patrolling above said area or cloud with the help of radiating necessary energy, and corresponding TUAVs are equipped for said heating with VHF radiators or IR lasers irradiating said land area or said cloud from above.

18. The system according to claim 17, wherein said means for air-to-air energy transfer from said UAVES to said TUAV are chosen from at least two implementations;
said system, wherein in the case of the first implementation: (1) said means comprise an extendable pylon equipped with double-line (consisting from two lines moving in the opposite directions) or circular conveyor intended for moving one or more said blocks between said UAVES and said TUAV; said extendable pylon is able to be pulled out from said UAVES; said conveyors are placed inside UAVES's and TUAV's fuselages; each of said conveyor is formed one or two lateral guide allowing moving said blocks step-to-step under the actions of pushers. All or almost all positions of UAVES's conveyor are occupied with said blocks, and one of said position is characterized in that the block occupying this position is connected to the electric supply line connected to said solar cells for charging as said conveyor is stopped and is disconnected as said conveyor moves;
(2) said UAVES and said TUAV are designed so that being are connected to each other by the way said extendable pylon said three conveyors form one single circular conveyor allowing changing said blocks between two said vehicles through ramps of each fuselage that are connected to the opposite sides of said pylon and that are opened after docking;
(3) said means of said UAVES and said TUAV are configured to execute further the following stages:
(i) approaching said TUAV to uniformly flying said UAVES using GPS signal(s), signal illumination and visualization means;
(ii) pulling out said extendable pylon and docking;
(iii) repeatedly executing for each said step and for each charged block: one charged block moves from said UAVES to said pylon, one charged block (previous) moves from said pylon to said TUAV, one discharged block moves from said TUAV to said pylon, and one discharged block moves from said pylon to said UAVES;
(iv) undocking said vehicles, pushing into said pylon, and moving off said vehicle away from each other;
(v-a) landing said TUAV near said ground-based station and changing from said charged blocks to discharging blocks; or (v-b) flying to a given position and heating said area: a rain cloud or a cold agricultural area.
(vi) repeating above said sequence beginning from step (1).

19. The system according to claim 18, wherein in the case of the second implementation each of said UAVESes is equipped with an extensible rigid boom including an aerodynamic equalizing means and an internal coaxial built-in flexible electrical multiple-conductor cable, an external end of said cable is equipped with a plug, an internal end of said cable is connected to UAVES' blocks via a special controlled conductor, and each of said TUAVs is equipped with a corresponding socket connected to internal (uncharged) blocks;
said UAVES and said TUAV is configured for executing: (i) moving forward or rear said boom from UAVES; (ii) approaching, catching said external end in a docking drogue fastened to said TUAV; (iii) inserting said plug into a socket placed inside said drogue and locking said plug; (iv) sending information about locking said plug, and after it switching on a contactor connecting said internal end of said cable to said charged blocks located inside said UAVES; (v) charging said internal TUAV' discharged blocks under control, and after complete charging sending a message about it and switching out said contactor; (vi) unlocking said plug, releasing said cable and moving back said boom; (vii) returning said UAVES for solar energy collection, and travelling said TUAV for said energy using or landing said TUAV for said energy transferring to said ground-based power station.

20. A geothermal self-supporting geothermal system, comprising an upper heat exchanger, a lower loop-shaped tubular heat exchanger located at predetermined depth inside subterranean cavity filled with high thermo-conductive material, two tubes located inside a borehole, thermo-isolated from ground and from each other, and connected an inlet of each of said two heat exchangers to an outlet of other;
said system, wherein the interiors of said two heat exchangers and two said two tubes form a through channel filled with a thermo-carrier non-freezing liquid at a predetermined temperature and having sufficient high temperature coefficient of density for self-supporting thermo-carrier's flow;
said system, comprising valve-type devices contributing to the initiation of the thermo-carrier's circulation in a predetermined direction;
said system, wherein: (a) said upper heat exchanger is made in the form of a plane coil pipe that is pressed to a plate made from a high heat-conductive metal or plastic material and having a lid on other side, the space between said plate and said lid is filled with a high heat-conductive mass; (b) said plate is located level with a surface or near said surface inside building or road structures or snow masses requiring a heating in winter; said plate admits an extension at different sides with the help high-conductive metal or plastic strips or heat pipes located in said structure or show masses;
said system, characterized in that said valve-type devices are chosen from: one or two liquid traps thermo-isolated from an ambient environment connecting said inlets of said heat exchangers and corresponding tubes, a built-in water pump occasionally included inside said channel, or their combination.
